(19) United States
(12) Patent Application Publication
(10) Pub. No.: US 2009/0115578 A1
(43) Pub. Date: May 7, 2009

(54) RADIO FREQUENCY ANIMAL TRACKING SYSTEM

(76) Inventors: Randolph K. Geissler, Hudson, WI (US); Steven Lewis, Bloomington, MN (US); Scott Alan Nelson, Eagan, MN (US)

Correspondence Address: MERCHANT & GOULD PC, P.O. BOX 2903, MINNEAPOLIS, MN, 55402-0903, US

(21) Appl. No.: 12/201,730

(22) Filed: Aug. 29, 2008

Related U.S. Application Data
(60) Provisional application No. 61/002,120, filed on Nov. 6, 2007.

(51) Int. Cl. H04Q 5/22

(52) U.S. Cl. 340/10.1

(57) ABSTRACT

An RFID system provides a transponder having a power store that can be recharged when located within an electromagnetic field generated by a transceiver unit. The power store can be a battery and/or a capacitor. In certain embodiments, the transponder can communicate over at least two different frequencies so that the real time performance of the transponder can be improved without losing backwards compatibility. The system provides an ear tag for use on livestock with superior durability and overall performance in the field.

### FIELD OF THE INVENTION

The invention relates to a radio frequency identification system and more particularly to a radio frequency identification system for tracking animals.

### BACKGROUND OF THE INVENTION

Radio frequency identification (RFID) systems are well known. RFID systems are active systems, wherein the transponder includes its own power source, semi-active, wherein a battery is used to power the memory storage, but not the transceiver, or passive systems, wherein the transponder receives all of its power from a base station. Since passive RFID systems do not require their own power source they are generally smaller, lighter, and cheaper to manufacture than active RFID systems. Consequently, passive systems are more commonly employed in RFID systems for the purpose of tracking as compared to active systems.

Passive RFID systems are generally either inductively coupled RFID systems or capacitively coupled RFID systems. Passive inductively coupled RFID systems are powered by the magnetic field generated by the base unit. Capacitively coupled systems, in contrast, are powered by the electric fields generated by the base unit. The present disclosure is applicable to both types of passive systems; however, the present description focuses on inductively coupled systems because they are presently more common due to the fact that they have a greater effective range than capacitively coupled systems.

Typically, an inductively coupled RFID system includes a transponder that has a microprocessor chip encircled by, and electrically connected to, a metal coil that functions as an antenna as well as an inductance element. The metal coil receives radio frequencies from a base station and generates an electrical current that powers the microprocessor, which is programmed to retrieve stored data such as an identification number and transmit the data back to the base station. Typically, a passive RFID system can transmit only over a limited range (e.g., on the order of about 25 inches) and can store limited information (e.g., an identification number).

Active and semi-active RFID systems include a battery configured to power the microprocessor. Active tags also use the battery to power the antenna to transmit signals as well. Active RFID systems typically have a transmission range (e.g., on the order of 100 meters) than passive RFID systems and enhanced memory capabilities. The batteries in active tags typically have a battery life of up to five years. Semi-active tags, which consume less power, tend to last longer. However, even these tags must be replaced after a relatively short period of time. Accordingly, an improved RFID system with a longer-lasting power source is desired.

Standard transmission frequencies have been established for RFID tags based upon their field of use. For example, 13.56 MHz is a standard radio frequency used for tracking manufactured goods, whereas 400 kHz is a standard radio frequency used for tracking salmon as they travel upstream to spawn. The standard radio frequency used for identification tags for livestock and other animals is currently 134.2 kHz. This relatively low radio frequency is advantageous because it can effectively penetrate water-containing objects such as animals. On the other hand, the frequency does not have a high transmission rate. Therefore, current RFID systems do not work well where fast data transmission is required, such as in certain real time tracking applications of fast moving objects. More particularly, due to the inherent signal transmission delay associated with current RFID systems operated at 134.2 kHz, current systems cannot in certain circumstances effectively query and retrieve identification numbers, also commonly referred to as identification codes, from identification tags as the animals move rapidly past a particular point in space, such as when cattle move along a cattle chute commonly found at auctions or disassembly plants. Accordingly, an improved RFID system with faster data transmission capabilities is desirable.

Unique challenges are associated with tracking livestock. In view of deadly livestock diseases such as Bovine Spongiform Encephalopathy more commonly known as Mad Cow disease, which have been known to infect herds and meat products, there is a strong global public interest in tracking livestock. As such, tracking livestock is increasingly becoming more common as well as highly regulated. One common means to track livestock requires livestock ranchers to apply for government-issued livestock identification numbers, which are forwarded to designated RFID tag manufacturers to be written into identification tags that are subsequently packaged and sold to the end user through authorized distributors. This complex multi-layered and multi-stepped process of manufacture and distribution is inefficient and costly. Accordingly, streamlining the process by providing a method and apparatus for manufacturing and/or processing the tags is desirable.

In addition, current identification tags manufactured according to the above outlined processes are typically not customizable by the end users and generally include only a stored identification number. Hence, if the producer wishes to track other data, the data must, for example, be stored on a separate computer and electronically associated with an identification number. This limitation may necessitate carrying a computer out in the field, which can be inconvenient and impractical. In addition, once the livestock changes hands, the new livestock handler may not have access to the data that is associated with the identification number because the data is not transferred to the new handler. Instead, the data must be stored on a network or otherwise deliberately made available to the new handler. Furthermore, current identification tags are not generally adapted to be used to measure physical parameters of the animals such as the animal's internal temperature, which can be helpful in determining if the animal is ill. Accordingly, it is desirable to developed an RFID system where the livestock handler can customize the identification tag; where data in addition to an identification number can be stored in the tag itself, where the livestock handler can use the tag to track physical parameters of the livestock in real time; and/or where the system remains compatible with current base stations.

### SUMMARY OF THE INVENTION

The invention is directed to an improved RFID system, methods of using the system, and methods of making the system. In an embodiment, the system includes a transponder that can communicate with a base station.

In certain embodiments, the transponder can communicate over two different frequencies. Such embodiments can provide improved real time performance of the transponder without losing backwards compatibility.

According to one embodiment, a radio frequency identification (RFID) tag for identification of animals includes a first antenna and a transponder coupled to the antenna. The transponder includes a first transmission unit, first memory and first power circuitry. The first power circuitry is configured to receive a current induced in the first antenna, and to power the first transmission unit and first memory. The first transmission unit is configured to retrieve data stored in the first memory and to transmit at least a portion of the data via the first antenna on a first carrier frequency and on a second carrier frequency.

According to another embodiment, a method of providing identification of an animal includes receiving a query from a base station with a radio frequency identification (RFID) tag in an animal. The query is responded to with a first transmission on a first carrier frequency and a second transmission on a second carrier frequency.

According to yet another embodiment, a method of identifying an animal to a base station with a radio frequency identification (RFID) tag includes providing the base station with a smallest identification number assigned to any of a plurality of RFID tags associated with a plurality of animals. A query from the base station is received with an RFID tag in the animal. The RFID tag being is a unique identification number. The received query is responded to with a reply transmission including an abbreviated identification number, which is the difference between the unique identifying number and the smallest identification number.

According to yet another embodiment, a system for identifying animals with radio frequency identification (RFID) tags includes a first base station configured to operate at a first carrier frequency. The system also includes a second base station configured to operate at a second carrier frequency. The system further includes a plurality of RFID tags each associated with one of a plurality of animals. Each RFID tag is configured to respond to a transmission on a first carrier frequency with a response transmission on the first carrier frequency and a response transmission on a second carrier frequency. At least one of the response transmissions includes a unique identification number.

According to yet another embodiment, a method of manufacturing a radio frequency identification (RFID) tag for identification of animals includes providing a substrate, and disposing a first coil upon the substrate. A first integrated circuit is coupled to the first coil. A first material is formed atop the first coil and first integrated circuit. A second material is formed over the first material.

According to yet another embodiment, a method of collision prevention for radio frequency identification (RFID) tags for identification of animals includes assigning each of a plurality of RFID tags a delay value. Each RFID tag is configured to receive a query from a base station, and to respond thereto by waiting for a duration of time corresponding to the delay value. Then, a response transmission is provided. The response transmission includes a unique identification number identifying an animal associated with the tag.

In an embodiment, the system includes an improved apparatus and method that allows the end user to customize and program identification tags. The invention includes the tags including user provided data in print and/or in electronic form.

In an embodiment, the system can provide an ear tag for use on livestock that exhibits advantageous performance in the field, shelter, and/or plant.

In an embodiment, the present invention relates to a flexible and/or implantable radio frequency identification system, such as a flexible and/or implantable radio frequency identification system for tracking animals.

In an embodiment, the system can provide an animal identification tag. The animal identification tag can include an RFID system, a flexible substrate, and a wrap. The tag can be configured with a rolled flexible substrate. The wrap can seal the RFID system from the surroundings.

In an embodiment, a method of manufacturing a radio frequency identification (RFID) tag for identification of animals includes providing a flexible substrate; disposing a first coil upon the substrate; coupling a first integrated circuit to the first coil; rolling the flexible substrate to produce a rolled tag; enclosing the rolled tag in a wrap, the wrap being effective for sealing the RFID system from the surroundings.

The present invention also relates to an identification tag for an animal. The tag can include an RFID system, a flexible substrate, and a wrap. The tag can be configured with a rolled flexible substrate. The wrap can seal the RFID system from the surroundings. The RFID system can include: a first circuit including a memory subunit, a power subunit, and a first transmit subunit, the subunits electrically connected to each other; a second circuit including a second transmit subunit, the second circuit electrically connected to the first circuit; an antenna connected to the first circuit. The power subunit of the first circuit can be configured to generate an electrical current when a radio signal is received by the antenna, and delivers this current to the first transmit subunit. The first transmit subunit can be configured to transmit a first signal at a first frequency when it receives electrical current from the power subunit, the first signal encoding at least a first portion of any data within the memory subunit. The second circuit can be configured to transmit a second signal at a second frequency when it when it receives electrical current from the power subunit, the second signal encoding at least a second portion of any data within the memory subunit.

### BRIEF DESCRIPTION OF THE DRAWINGS

The accompanying drawings, which are incorporated in and constitute a part of the description, illustrate several aspects of the invention and together with the detailed description, serve to explain the principles of the invention. A brief description of the drawings is as follows:

FIG. 1 is a diagrammatic illustration of a known RFID system commonly used to track livestock in accordance with the principles of the present disclosure;

FIG. 2 is a diagrammatic illustration of an RFID transponder located within a geographic region over which a base unit can generate an electromagnetic field in accordance with the principles of the present disclosure;

FIG. 3 is a diagrammatic illustration of an RFID system having features that are examples of inventive concepts in accordance with the present invention;

FIG. 4 is a diagrammatic illustration of an RFID transponder having a wire loop antenna, a battery, and a semiconductor chip in accordance with the principles of the present disclosure;

FIG. 5 is a diagrammatic illustration of a transponder moving out of the electromagnetic field of an RFID system in accordance with the principles of the present disclosure;

FIG. 6 is a transponder transmitting a signal to a base unit when the base unit is not generating an electromagnetic field in accordance with the principles of the present disclosure;

FIG. 7 is a diagrammatic illustration of an RFID system according to the principles of the present invention;

FIG. 8 is a diagrammatic illustration of a portion of the manufacturing of the identification tag of the RFID system of FIG. 7 in accordance with the principles of the present disclosure;

FIG. 9 is a diagrammatic illustration of a top view of a strip of identification tags of FIG. 8 in accordance with the principles of the present disclosure;

FIG. 10 is a diagrammatic illustration of the finishing process of the identification tag of the RFID system of FIG. 7 in accordance with the principles of the present disclosure;

FIG. 11 is a front elevation view of an identification tag according to the principles of the present invention;

FIG. 12 is a schematic diagram of an alternative embodiment of a substrate on which identification tags according to the present invention may be formed;

FIG. 13 is a schematic diagram of an encoding device for use with the identification tags of FIG. 12 in accordance with the principles of the present disclosure;

FIG. 14 is a schematic diagram of a forming device for forming identification tags upon the substrate of FIG. 12 in accordance with the principles of the present disclosure;

FIG. 15 is a perspective view of a printing device for printing onto the identification tags of FIG. 12 in accordance with the principles of the present disclosure;

FIG. 16 is a perspective view of a second embodiment of a printing device for printing onto the identification tags of FIG. 12 in accordance with the principles of the present disclosure;

FIG. 17 is a representation of communication between the printing device of FIG. 16 and a remote database in accordance with the principles of the present disclosure;

FIG. 18 is a schematic diagram of animals tagged with an identification tag moving through a chute adjacent a transceiver in accordance with the principles of the present disclosure;

FIG. 19 schematically illustrates an embodiment of an identification tag in its rolled configuration in accordance with the principles of the present disclosure;

FIG. 20 illustrates an animal tracking system, which includes a rechargeable identification tag coupled to an animal, for dairy applications in accordance with the principles of the present disclosure;

FIG. 21 is a schematic diagram of an electrical circuit arrangement that can be used to implement the identification tag of FIG. 20 in accordance with the principles of the present disclosure;

FIG. 22 is a flowchart illustrating an operational flow for an example exchange process by which a power store of an identification tag can be recharged in accordance with the principles of the present disclosure;

FIG. 23 is a flowchart illustrating an operational flow for another example exchange process by which a power store of an identification tag can be recharged in accordance with the principles of the present disclosure; and

FIG. 24 is a circuit diagram showing an example recharging circuit that can be used by the tag to recharge the power store in accordance with the principles of the present disclosure.

### DETAILED DESCRIPTION OF THE INVENTION

Definitions

As used herein, the term “animal” refers to macroscopic animals including vertebrates. Animals include domesticated animals, such as livestock and companion animals, and wild animals, such as game animals or fish. Livestock include animals such as swine (pig), piglet, sheep, lamb, goat, bovine (e.g., cow), fish and (e.g., salmon), birds (e.g., chickens, ducks, and geese). This list of animals is intended to be illustrative only, and should not limit the scope of any of the following disclosure related to the present invention. As used herein, the term “track” refers to the identification, location, recording, and monitoring of animals or other objects of interest, for whatever purpose or reason. This definition is illustrative of uses of the present invention and is not intended to limit the scope of any of the following disclosure related to the present invention.

Tag, Method, and System

An identification tag for an animal, the tag including an antenna and a first circuit including a memory subunit, a power subunit, and a first transmit subunit, the subunits electrically connected to each other. The power subunit of the first circuit is configured to generate an electrical current when a radio signal is received by the antenna. The power subunit also can deliver none, some, or all of the current to the first transmit subunit. The first transmit subunit is configured to transmit a first signal at a first frequency when it receives electrical current from the power subunit, the first signal encoding at least a first portion of any data within the memory subunit.

In certain embodiments, the tag also includes a powered or semi-powered transmitter with an on-board power supply, as compared to the transmitters described above which receives power induced from a magnetic field. For example, the tag can include a battery subunit in electrical communication with the power subunit. The power subunit is also configured to deliver none, some, or all of the induced power to the battery subunit for storage.

Such embodiments can still be triggered to transmit the first signal when the electrical current is induced by the magnetic field created by a base unit, but the on-board power supply (e.g., the battery subunit) might provide for higher signal strength or greater length of transmission than might be possible with the induced power embodiment shown above. By semi-powered, it is intended to mean that the tag would still receive some power via induction through coil but that more power than that induced might be available for transmission.

In an embodiment, an identification tag for an animal includes a first circuit, an antenna, and a battery. The first circuit includes a memory subunit, a power subunit, and a first transmit subunit. The subunits electrically connected to each other. The antenna is electrically connected to the first circuit. The antenna is configured to receive radio signals, to induce an electrical current when a radio signal is received by the antenna, and to direct the induced electrical current to the power subunit. The battery electrically connected to the first circuit. The first transmit subunit of the first circuit is configured to transmit a first signal at a first frequency when the first transmit subunit receives electrical current from the power subunit. The first signal encodes at least a first portion of any data stored within the memory subunit. The power subunit of the first circuit is configured to deliver at least some of the current induced by the antenna to the battery for storage to recharge the battery.

In certain embodiments, the tag also includes a second circuit including a second transmit subunit, the second circuit electrically connected to the first circuit and to the antenna. The second circuit is configured to transmit a second signal at a second frequency when it when it receives electrical current from the power subunit, the second signal encoding at least a second portion of any data within the memory subunit.

A method of charging an identification tag for an animal including providing a base unit including a transceiver configured to emit and receive radio wave signals. The radio wave signals generate an electromagnetic field over a geographic area extending outwardly from the base unit. The method also includes providing an identification tag having a data transponder, a battery, and a memory storage. The data transponder receives the radio waves when positioned within the geographic area of the electromagnetic field. The data transponder generates an electrical charge based on the field. At least a portion of the electrical energy is delivered to the battery for storage.

In certain embodiments, a portion of the generated electrical energy is delivered to the battery and another potion of the energy is used by the data transponder to obtain data from the memory storage. In some embodiments, yet another portion of the energy is used by the data transponder to transmit a signal encoding the obtained data to the base unit. In other embodiments, the energy stored in the battery is used to transmit a signal encoding the obtained data to the base unit at a later time. In still other embodiments, the base unit can instruct the transponder not to transmit all or part of its data. When instructed not to transmit any data, all of the induced electrical energy can be stored in the battery. The data transponder can retrieve the energy at a later time to access the memory storage and to transmit a signal to the base unit.

In some embodiments, the base unit continuously transmits radio waves over the geographic area to maintain the electromagnetic field. In other embodiments, however, the base unit periodically or intermittently transmits radio waves over the geographic region.

A method of making an identification tag for an animal including providing a producer of animals, at least one animal, an animal identification tag with a data transponder, a battery, and a memory storage, and a tag printer located adjacent a space for confining the at least one animal. At least one registration code is acquired to be assigned to the at least one animal. The at least one registration code is input to the tag printer. The animal is positioned in the confined space adjacent the tag printer. The animal identification tag is positioned within the tag printer. The registration code is printed on an exterior of the animal identification tag. The registration code is written into the memory storage of the animal identification tag. The animal identification tag is removed from the machine and attached to the animal.

An animal identification tag includes a flexible substrate including upper and lower portions. A substantially rigid transponder mount is positioned between the upper and lower portions. A transponder is mounted to the transponder mount. The transponder includes a data memory storage, an antenna, power circuitry, a battery, and transmission circuitry. The power circuitry is configured to generate electrical current when a first radio signal at a first frequency is received by the antenna. The battery is configured to store at least a portion of the generated current. The transmission circuitry is configured to transmit at least a portion of any data within the data memory storage at a second frequency, and to transmit at least a portion of any data within the data memory storage at a second frequency when electrical current is received from either the power circuitry or the battery. A mounting opening extends through the upper and lower portions and a mounting opening reinforcement mounted between the upper and lower bodies adjacent the mounting opening.

A device for making animal identification tags including a housing with a path along which an animal identification tag may be positioned. A data writing apparatus is located within the housing adjacent the path and positioned to write digital information to a data storage of the animal identification tag. A printing device is located within the housing adjacent the path and positioned to print information on an exterior of the animal identification tag. An optical scanner is located within the housing and positioned adjacent the path to optically scan the printed information on the exterior of the animal identification tag. A radio frequency generator and receiver is located within the housing and positioned adjacent the path to query the digital information written into the data storage of the animal identification tag.

A method of tracking livestock includes registering an identification code with a central database, wherein registering includes associating the identification code with a user name. A radio frequency identification tag is provided. The identification code is written to the radio frequency identification tag. Subsequently additional data is written to the radio frequency identification tag. In some embodiments, the identification tag is a passive radio frequency identification tag. In other embodiments, however, the identification tag is an active or a semi-active radio frequency identification tag.

A method of tracking livestock including registering an identification code with a central database, wherein registering includes associating the identification code with a user name. A radio frequency identification tag is provided. In an embodiment, the identification code is written to the radio frequency identification tag. In another embodiment, the identification code is written to the radio frequency identification tag at a physical location where an animal to be tracked is located. In an embodiment, the radio frequency identification tag is queried using a first frequency and transmits a response at a second frequency. In some embodiments, the identification tag is a passive radio frequency identification tag. In other embodiments, however, the identification tag is an active or a semi-active radio frequency identification tag.

A radio frequency identification tag includes a flexible substrate and a transponder position within the flexible substrate. In some embodiments, the transponder includes a passive inductance radio frequency device positioned within a substantially rigid housing. In other embodiments, the transponder includes a semi-active or active radio frequency device.

The present invention includes an animal, the animal including an appendage (e.g., an ear) a tag according to the present invention.

### Illustrated Embodiments

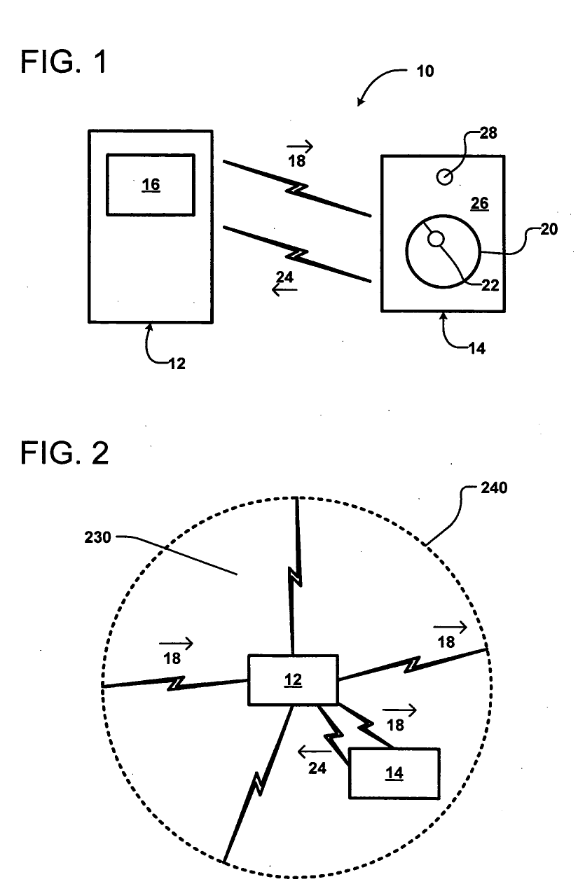

Referring to FIGS. 1 and 2, a conventional passive RFID system 10 is shown. The conventional passive RFID system 10 includes a base station 12, also commonly referred to as a reader, and a transponder 14, also commonly referred to as an identification tag (FIG. 1). In the depicted RFID system 10, the transponder 14 and base station 12 are configured to track and/or management animal tags. The base station 12 includes a transceiver 16 that emits a radio signal 18, which may be received by the transponder 14. For example, the base station 12 and transponder 14 can be configured to transmit and receive radio waves at the current industry standard for RFID livestock tracking, which is 134.2 kHz.

Emitting the radio signals 18 generates an electromagnetic field 230 over a geographic region 240 (see e.g., FIG. 2). The transponder 14 includes a wire loop antenna 20, which receives the signal 18 when the transponder 14 is located within the geographic region 240 when the electromagnetic field 230 is being generated. The wire loop antenna 20 functions as an inductor to generate an electric current from the signal 18. The generated electric current powers a semiconductor chip 22, which is programmed to retrieve a stored identification number/code, to convert the number into a signal 24, and to transmit the signal 24 back to the transceiver 16 in the base station 12.

In some conventional tag management systems 10, the transponder 14 only transmits a signal 24 back to the base unit 12 when exposed to the electromagnetic field 230 generated by the base unit 12. In other conventional systems, a persistent power source (e.g., a battery) can be incorporated into the transponder 14. However, the battery will eventually be drained of power. After the battery has been depleted, the battery or the entire transponder 14 must be replaced.

In the case of identification tags on animals (e.g., beef cattle, dairy cows, other types of livestock, animals tracked in the wild, etc.), replacing the tags can be time consuming and burdensome. A new tag must be obtained and programmed, the animal must be caught, the old tag must be removed from the animal, and the new tag must be coupled to the animal. Typically, animal tags, such as those used on livestock, are sealed from the environment (e.g., from moisture, dirt, or other such contaminants). Such a seal inhibits access to the battery making replacement difficult or impossible. Further, the battery size is limited by a maximum weight that can be supported by the animal. For example, some identification tags are attached to an ear of the animal. Such an appendage can support only so much weight.

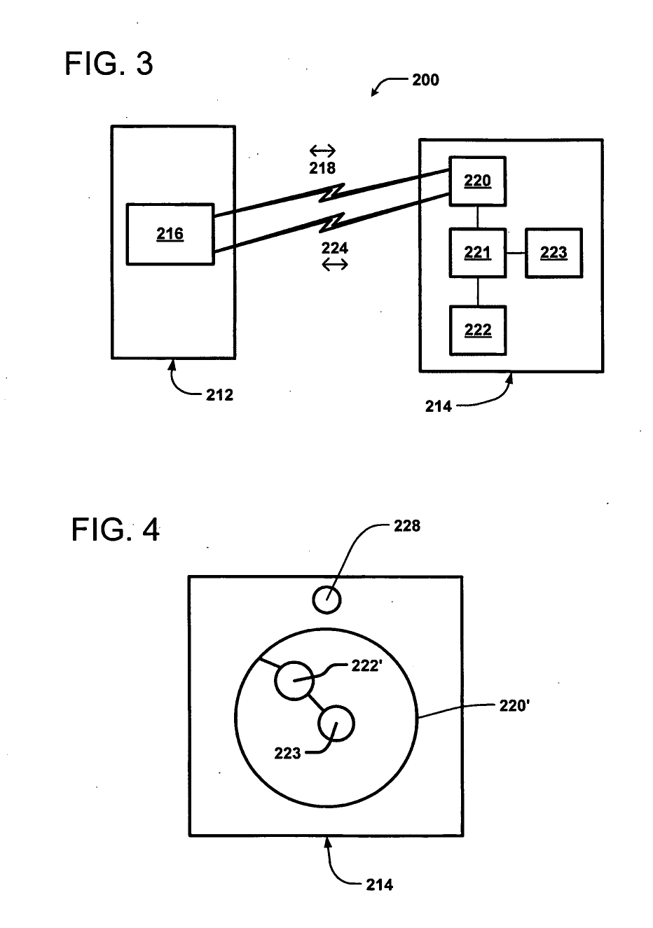

Referring now to FIGS. 3-6, there are a variety of combinations of fully- and semi-powered transmission capabilities that may be included within the present invention. A first embodiment of a tag management system 200 includes a base station 212, also commonly referred to as a reader, and a transponder 214, also commonly referred to as an identification tag.

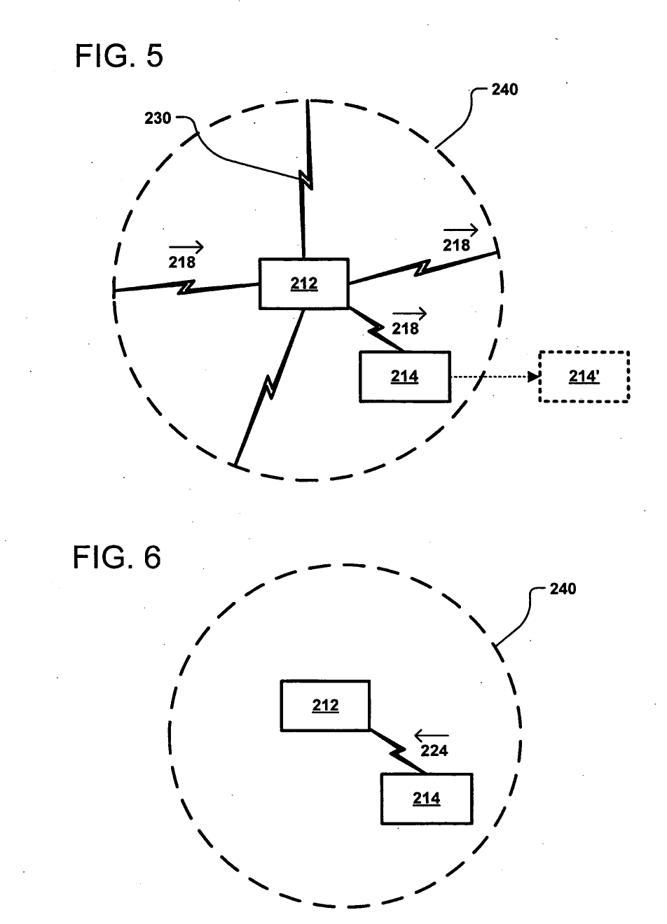

The base station 212 includes a transceiver 216 for emitting and receiving radio waves 218 to generate an electromagnetic field 230 over a geographic area 240 (see FIG. 5). In one embodiment, the frequency of the radio waves can be the standard frequency of 134.2 kHz. Of course, higher and lower radio wave frequencies are consistent with the scope of the disclosure. In some embodiments, the electromagnetic field 230 produced by the base station 212 is maintained over the geographic area 240 continuously. In other embodiments, the field 230 is generated at predetermined intervals. In one embodiment, the field 230 is generated at regular, periodic intervals.

The transponder 214 includes an antenna 220 configured to receive and transmit radio waves, an inductor 221 configured to convert the received radio waves (i.e., the field 230 generated by the radio waves) into electrical energy, a memory storage 222 for storing data, and a power store (e.g., battery, capacitor, etc.) 223 for storing electrical energy (see FIG. 3). In some embodiments, the memory storage 222 is provided on an integrated circuit chip (e.g., see semiconductor chip 222′ of FIG. 4). In certain embodiments, a wire loop 220′ (FIG. 4) can function as both the antenna 220 (FIG. 3) and the inductor 221 (FIG. 3) to generate an electrical current based on the received radio waves.

In some embodiments, the current generated by the inductor 221 can be used to power the transponder 214 to process and transmit data. For example, in one embodiment, the current can power a semiconductor chip 222′ (FIG. 4). The semiconductor chip 222′ can be programmed to store an identification number, to retrieve the stored identification number from memory, and to transmit that identification number back to the base station 212 via the antenna 220 or a different antenna. In another embodiment, the current generated by the inductor 221 can power the antenna 220 to modulate the received signal to provide a response to the base station 212.

In certain embodiments, at least a portion of the electrical current generated by the transponder (e.g., by inductor 221 or by wire loop 220′) can be delivered to the power store 223 for storage and later retrieval. In such embodiments, the power store 223 is recharged while the transponder 214 is located within the geographic area 240 of the field (see FIG. 5). The power store 223 ceases recharging when the transponder 214 moves outside the geographic region 240 as shown at reference number 214′ of FIG. 5.

In some embodiments, the electrical current generated by the transponder 214 (e.g., by inductor 221 or by wire loop 220′) can be directed to a capacitor (e.g., a supercapacitor, an ultracapacitor, etc.) for storage. The capacitor can at least partially recharge itself with current induced from a query signal between data signal transmissions. In other embodiments, the transponder 214 can include a rechargeable battery 223 to which the electrical current can be directed. In some embodiment, the transponder 214 only remains within the boundaries of the electromagnetic field 230 to enable the battery to recharges only partially. In other embodiments, however, the transponder 214 remains within the field 230 a sufficient time to enable the battery to recharge fully. Recharging the battery 223 provides the transponder 214 with a longer battery life, thereby decreasing the amount of time and energy required to replace the transponder 214 in the field.

Energy retrieved from the power store 223 can be used to power the transponder 214 even after the transponder 214 has left the geographic area 240 over which the electromagnetic field 230 extends or after the base station 212 has ceased generating the electromagnetic field 230. For example, a battery or capacitor-type power store 223 can enable the transponder 214 to retrieve data from the memory 222, to edit data stored in the memory 222, to write new data into the memory 222, and/or to perform another desired function. The power store 223 also can store sufficient power to enable the transponder 214 to transmit a signal 224 containing data retrieved from the memory 222 to the base unit 212.

It is also anticipated that an on-board battery and an on-board capacitor may be used in conjunction with one another to form the power store 223. In some such embodiments, the capacitor is configured to receive some induced current from the query signal 218, which would trigger transmission of a data signal 224 to the base unit 212. While the charge within the capacitor may be sufficient to permit transmission of the signal 224, the battery can be used to enhance the power of the signal 224 to boost range and/or signal strength. Such a pairing of capacitor and battery may extend the life of the battery by only tapping it for supplemental power to augment the power provided by the capacitor. Such a pairing of power sources for transponder 214 could provide for enhanced range of data transmission and may also permit transponder 214 to transmit a greater volume of data.

A higher power transmission in response to a query signal 218 also can be accomplished on a periodic basis when transponder 214 is continuously within range of a query signal 218. Because the query signal 218 (i.e., or the field generated from the signal 218) may be used to induce an electric current in transponder 214 to power operation, if transponder 214 is continuously in range of such a signal, the induced current could be directed to a capacitor. When the capacitor has reached a certain level of charge, a burst mode of transmission could be enabled. Similarly, the on-board battery 223 could be used to provide a periodic burst transmission. In one such case, transmission intervals may be based on a clock cycle rather than a capacitor charge level. For example, while within range of the query signal, transponder 214 may transmit data in burst mode every ten minutes, or some other pre-specified interval.

When using a non-rechargeable battery or a capacitor, such a high power transmission may be supported only for a limited number of operations before draining the battery. Consequently, in such embodiments, the number of bursts performed in response to a query signal 218 is typically smaller. It is also anticipated that an on-board capacitor may provide a more persistent storage of at least a partial charge, rather than discharging entirely during transmission. If the transponder 214 only transmits for a specified period of time when exposed to a query signal, any remaining charge within the capacitor could be conserved to support future transmissions. In addition, if transponder 214 remains within range of the query signal after completing the specified length of transmission, exposure to the query signal could also induce current to provide additional charge to the capacitor.

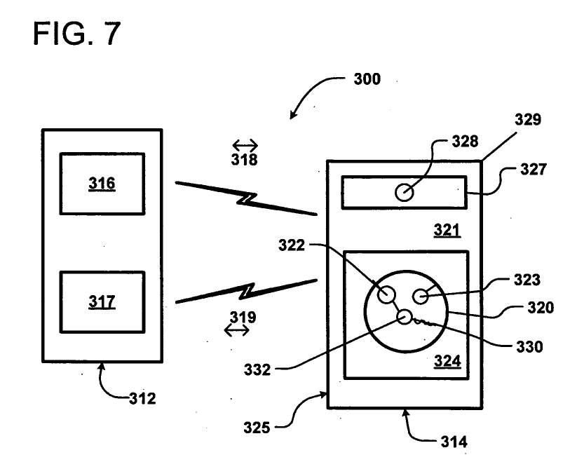

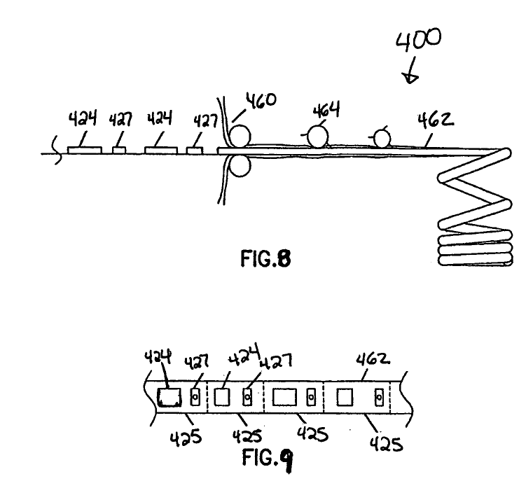

To facilitate the identification of animals in a dynamic environment in which the animals move rapidly past a tag reader, such as at a gate at a cattle ranch, certain embodiments of the tag management system 200 have components that transmit and receive data using two or more radio wave frequencies. For example, FIG. 7 is a schematic diagram of another example tag management system 300 having a base station 312 and a transponder 314. The base station 312 includes a first device 316 for transmitting and receiving signals at a first frequency 318 and a second device 317 for transmitting and receiving signals at a second frequency 319. In an embodiment, the first frequency 318 can be the standard frequency of 134.2 kHz and the second frequency 319 can be a higher frequency than the first frequency 318.

In the example shown in FIG. 7, the transponder 314 includes an antenna, e.g., a wire loop antenna 320, which is configured to receive and transmit on the first frequency 318. In one embodiment, the wire loop antenna 320 is made of metal and also functions as an inductor to generate an electrical current for powering a first semiconductor chip 322. The first semiconductor chip 322 can be programmed to retrieve a stored identification number and transmit that identification number back to the first device 316 of the base station 312 over the first frequency 318. In addition, the first semiconductor device 322 can be programmed to transmit the identification number back to the second device 317 of the base station 312 over the second frequency 319 via a second antenna 330. This alternative mechanism for transmitting a signal back to the base station 312 can decrease the response time of the tag management system 300. At the same time, the tag management system 300 can be configured to remain compatible with existing systems that operate at lower frequencies.

In some embodiments, the transponder 314 also includes a power store (e.g., a rechargeable battery, a capacitor, etc.) 323 coupled to the first antenna 320. The power store 323 is configured to store at least some of the electrical energy generated by the antenna/inductor 320. The power store 323 also is configured to provide electrical energy to the first semiconductor chip 322. The power store 323 also can be configured to provide energy to the antenna 320 to transmit a signal to the first device 316 of the base unit 312 over the first frequency 318. In some embodiments, the second antenna 330 can generate an electrical current and can deliver the current to the rechargeable power store 323. In other embodiments, the second antenna 330 is configured to retrieve power from the power store 323 to transmit a signal to the base unit 312 over the second frequency 319.

In the depicted embodiment, the transponder 314 further includes a second semiconductor chip 332 that is electrically connected to the first semiconductor chip 322. The second semiconductor chip 332 is shown powered by the current generated by the first antenna 320. The second semiconductor chip 332 can be configured to transmit a signal at the second frequency 319. In some embodiments, the second semiconductor chip 332 is configured so that the second semiconductor chip 332 of the tag management system 300 is very similar, or even identical, to the first semiconductor chip 322. In certain embodiments, the power store 323 is electrically coupled to the second semiconductor chip 332.

It is anticipated that the two or more transmission circuits (e.g., semiconductor chips 322, 332) included on transponder 314 could transmit in distinctly different fashions, in response to a query signal. For example, one of the transmission circuits can respond by transmitting continuously for a fixed period of time, or until the level of power available in the capacitor or battery 323 connected to the circuit dropped below a specified level. One of the transmission circuits might transmit data only a specified number of times (e.g., 1 to 3 times) in a burst mode only in direct response to a query signal. This burst mode could be a higher power transmission that draws power from the power store 323.

Still referring to FIG. 7, in the depicted embodiment the first chip 322 and/or the second chip 332 can include a writeable memory device for storing customizable programmable data. The first and second semiconductor chips 322, 332 can store any of a variety of data, such as data about an animal. For example, the health history, genetic characteristics, the date and location of sale, as well as other data may be stored in the memory of the second semiconductor chip 332. Alternatively, such data can be written to a data storage location of the first semiconductor chip 322. This data from the first semiconductor chip 322 could be transmitted to the base station 312 at the second higher frequency via the second semiconductor chip 332. Alternatively, the customizable programmable data can be transmitted to the base station 312 at the first frequency 318 via the first semiconductor chip 322. The second frequency 319 can be beneficial when the medium of transfer is air, which allows for higher frequency rates and, consequently, faster rates of transfer than other materials such as water or cement.

In the various embodiments herein, the communication link(s) (e.g., communication links 318 and 319) can be conducted in either half duplex or full duplex. Thus, in the context of a half duplex embodiment, a base station, such as the base station 312 depicted in FIG. 7, may transmit a relatively low frequency carrier (e.g., 134.2 kHz) to the transponder 314, thereby transferring power to its internal circuitry. After having transferred energy to the transponder 314, the base station 312 ceases its transmission, and enters a period wherein its transceiving devices 316 and 317 attempt only reception of data.

The transponder 314 is configured to receive energy during this transfer period, but to delay its return transmission(s), until the base station 312 ceases transmission. During this cessation period, the transponder 314 can respond with one or more return transmissions. For example, the transponder 314 can simultaneously return transmission on both high and low frequency carriers 318 and 319. Alternatively, the transponder 314 may divide this period into two timeframes—a first timeframe, during which transmission on the low frequency carrier 318 is performed, and a second timeframe, during which transmission on the high frequency carrier 319 is performed. In the wake of having received a return transmission, the base station 312 may re-enter its energy transfer phase, thereby beginning the cycle anew.

In contrast, in the context of a full duplex embodiment, transmissions to and from a base station, such as base station 312, and a transponder, such as transponder 314, occur substantially simultaneously. Full duplex schemes exhibit the quality of permitting a greater quantity of data to be communicated in a given interval of time. For this reason, under certain circumstances, full duplex embodiments may be desirable.

On the other hand, half duplex systems may allow for a more reliable return communication from a transponder. In certain environments, the signal emanating from the base station may reflect off of one or more surfaces, and return to the base station. In such a circumstance, if the communication was conducted in full duplex, the base station would also be receiving a return transmission from the transponder, meaning that the reflected signal and the return transmission would interfere with one another. A half duplex system reduces such interference by delaying return transmissions until the base station is no longer transmitting (when the base station ceases transmission, it ceases to emit signals that can be reflected back to itself, causing the unwanted interference). Half duplex systems possess other advantages in terms of simplicity and cost, as well.

In embodiments in which the transponder 314 includes a power store 323, the transponder 314 can wait a significant period of time before responding to the base station 312. In some embodiments, the tag management system 300 includes multiple transponders 314 and each transponder 314 is configured to respond to the base station 312 at a different predetermined time, thereby reducing the chance of interference between signals. In other such embodiments, the transponder 314 can respond to the base station 312 at periodic intervals without receiving intervening signals from the base station 312.

In alternative embodiments the second semiconductor chip 332 can be configured to communicate with an implanted biosensor that can detect a physical characteristic including, for example, the animal's temperature and/or blood characteristics. It is anticipated that these biosensors could be incorporated into a local data bus for the animal and that the transponder 314 could serve as a storage device or a retransmission device for data collected and signaled by the biosensors. Such a sensor may be integrated with transponder 314 or may be separately implanted inside the animal.

In some embodiments where the sensor is integrated with the transponder 314, the sensor can obtain power from the power store 323. In embodiments where the transponder 314 is separate from the sensors, the sensors may use a separate, internal power source to communicate with transponder 314, which in turn communicates with the base station 312. In such embodiments the data can be sent back to the base station 312 for analysis via the first frequency 318 from the first antenna 320 or the second frequency 319 from the second antenna 330. Depending on the surrounding conditions the first or second frequency may be preferred. For example, if only air separates the transponder 314 and the base station 312, the faster, higher frequency may be preferred because of the fast transmission rate, whereas if there are cement walls or other solid or water-containing objects between the base station 312 and the transponder 314 the lower frequency may be preferred due to its ability to penetrate objects. Alternatively, it should be appreciated that the biosensors could also communicate directly with the base station 312.

In certain embodiments, the biosensor devices can take advantage of the extra power provided by the power store 323. In such an arrangement, the biosensors would have low level communication capabilities that would be sufficiently strong to transmit data to transponder 314, which might be attached, for example, to an ear of the animal. Transponder 314 would then retain some amount of information, such as the most recent data from the biosensors, and then transmit this data in response to a query signal. The power required to transmit this additional data received from the biosensors and held by transponder 34 may make the additional transmission capacity provided by including the persistent on-board power supply.

The transponder's ability to store more data than an identification number can be beneficial because, for example, a tagged animal is often handled or processed by a number of different individuals. Ensuring that each individual has access to the data associated with the animal when the data is stored remotely from the animal can be difficult and expensive. However, when the data in the tag management system 300 is stored on at least one of the semiconductor chips 322, 332 attached to the animal, the handler of the animal can gain access to the relevant information about the animal.

Still referring to FIG. 7, the transponder 314 is shown as an embodiment of an identification tag 325 configured to attach to an animal. The tag 325 can be configured to attach to any of a variety of parts of an animal, such as to a wing, leg, ear, fin, flipper, tail, or any other suitable appendage or portion of the body of the animal or object to be tracked. In an embodiment, identification tag 325 is configured to attach to the ear of an animal, for example, an ear of a cow. The identification tag 325 is shown to include optional protective housing 324 and optional grommet 327 that are contained and/or sealed within a flexible outer shell 329. The grommet 327 can define and reinforce an opening 328 defined through the housing 325 and outer shell 329.

In certain embodiments, the protective housing 324 houses the wire loop antenna 320. The protective housing 324 in the depicted embodiment houses the wire loop antenna 320, the second antenna 330, the power store 323, and the first and second semiconductor chips 322 and 332, respectively. In this embodiment, the protective housing 324 is designed to protect the electronic components of the transponder 314 from damage as a result of physical trauma such as bending or crushing. The protective housing 324 is, thus, generally at least semi-rigid. In some embodiments, the housing may be made in the form of a plastic disk and include a hole 328 that is sized to receive a fastener for attaching the housing 324 directly to the ear of an animal.

In the depicted embodiment, the identification tag 325 is constructed to be connected to the animal's ear with a fastener. The grommet 327 prevents the area of the identification tag 325 that engages the fastener from ripping or tearing due to concentrated physical stresses at the point of engagement. The grommet 327 is shown as a tab of reinforced material. The grommet 327 can be constructed of many different types of materials including, for example, metal, plastic, or nylon. The flexible outer shell 329 of the identification tag 325 encloses the housing 324 and can seal the protective housing 324 and the reinforced material of the grommet 327 from the external environment. The inclusion of the flexible outer shell 329 makes the entire identification tag 325 more likely to yield when it impacts foreign objects such as fence posts and the like. Accordingly, the arrangement including the flexible outer shell 329 decreases the chance that the identification tag 325 would injure an animal.

Referring to FIGS. 8-11, a manufacturing process for manufacturing an identification tag 425 and a system 400 for implementation thereof are shown. The method may include the step of enclosing or encapsulating housings 425 within or as part of a flexible outer shell 429. As an example, nip rolling 60 for laminating flexible outer shell 429 around housings 424 including electronic components therein may be used to form a strip 462 of connected identification tags 425 (see FIG. 8). In the depicted embodiment reinforced material is also laminated within the outer shell 429. It is anticipated that other processes or mechanisms may be used to encapsulate or enclose housings 424 to form strip 462 and tags 425 within the scope of the present disclosure and the examples provided above are merely illustrative.

The depicted method further includes the step of perforating 464 the identification tags 425 so that the tags 425 can be detached from each other by tearing the strip 462 along the perforations 64 (see FIG. 9). The method may further include the step of punching a hole 428 in the identification tag 425 that is sized to receive a fastener for attaching the identification tag 425 to the ear of an animal. It should be understood that the method might include greater or fewer steps. For example, in one embodiment the hole 428 is punched in the identification tag 425 by the tool used to attach the identification tag 425 to the animal's ear. In other embodiments, the identification tags 425 are not perforated, but rather are cut with a pair of scissors before use. Furthermore, in the embodiment shown, the strip 462 is folded over itself for storage. However, it should be appreciated that the strip 462 could also be rolled over itself for storage.

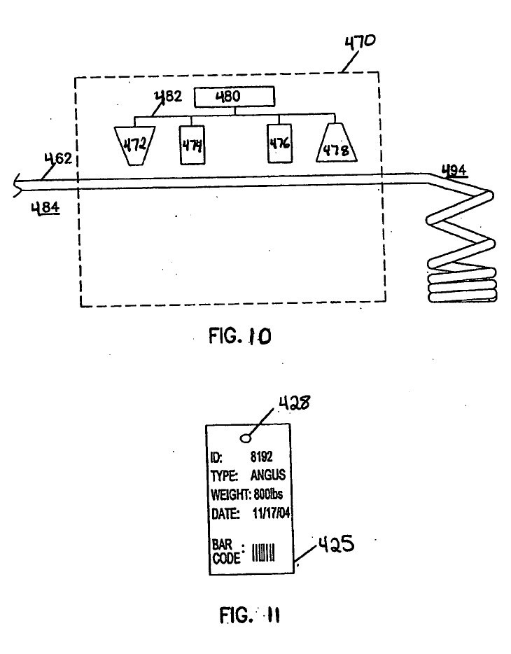

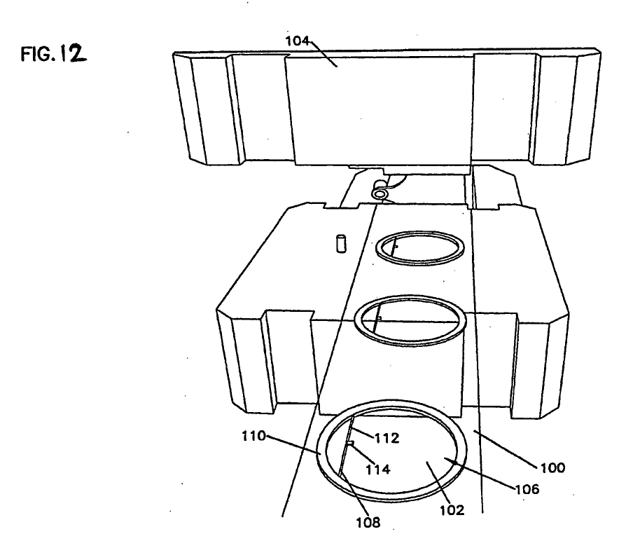

Referring to FIG. 10, an apparatus and method for customizing and finishing the strip 462 of identification tags 425 is illustrated. In the depicted embodiment an identification tag processor 470 is shown to include an identification tag writer 472, a printer 474, an optical reader 476, a radio frequency reader 478, and a central processing unit 480 otherwise referred to as a controller. The above-identified devices of the tag processor 470 are shown hardwired together via wires 482. Nonetheless, it should be appreciated that the devices can be connected without wires such as via infrared signaling. In addition, it should be understood that identification tag processor 470 may include more or less devices than are shown in FIG. 8. For example, in some embodiments the optical reader 476 is omitted and the verification is done manually. In other embodiments the identification tag processor 470 includes additional devices such as a touch panel user interface. The functions of the individual devices identified above are addressed in further detail below.

The depicted method of customizing and finishing the strip 462 of tag 425 includes loading 484 the strip 462 into the identification tag processor 470. The method can include writing 486 such as with the tag writer 472 the identification number and other data defined by the end user to the memory of the identification tag 425. The method can include printing or otherwise marking 88 (FIG. 11) the outer surfaces of the identification tags 425 with text, bar codes, etc, defined by the end user, such as with the printer 474. The identification tags 425 can include any number of different kinds of markings, which can be determined at the site of printing by the operator of the system. For example, in the embodiment of the identification tag 425 shown in FIG. 11, the identification tag 425 is marked with an ID number, the particular animal type, a bar code, and the weight of the animal at a particular date. The other data or marking can include, for example, the date and time that the tag is being printed or that the animal arrived at or departed from the facility.

Once the outer surface of the identification tag 425 is printed or otherwise marked 488, the outside marking can be verified by a device such as the optical reader 476 (FIG. 10) that reads the markings and compares the read marking to the intended markings. Such devices may employ, for example, well known optical character recognition technology. Similarly, once the identification number or code is written to the inner electronic components of the identification tag 425, the writing of the identification number can be verified by a device such as radio frequency reader 478 (FIG. 10) that reads the identification number and compares the read number with the number that was intended to be written. According to the above process, the tags are processed and the accuracy of the processing is checked. It should be understood that though the processing can be accomplished at one physical location as shown in FIG. 10, in alternative embodiments, the processing can occur in different physical locations and in a different order. On the other hand, in some embodiments the optional laminating process shown in FIG. 8 is integrated with the finishing processes shown in FIG. 10 so that the identification tag can be generated completely on site.

It is anticipated that the tag writer 472 may be configured so that a producer or other user may be required to input each identification number in turn to enable the writing of that number to the memory and printing of the tags. Alternatively, tag writer 472, or an associated device connected via a network or any wired or wireless connection, may be pre-loaded or authorized to dispense a certain set of identification numbers. In an operation analogous to a refillable postage meter, a producer may request a set of identification numbers be assigned to the particular premises in anticipation of a need to tag and identify animals. In such an arrangement tag writer 472 could then dispense tags printed and coded with those pre-loaded numbers, improving efficiency of tagging operations that may be carried out chute-side at the producer's premises. Data entry errors may be reduced as well, improving the accuracy of tracking of the tagged animals. When the producer has exhausted the set of numbers that have been assigned to the tag writer 472, the producer may request that a new set of numbers be approved so that the tag writer 472 can be “refilled.”

In an embodiment of the current system the memory device in the transponder 14 can be written only once. In certain situations this type of system is preferred because it ensures that the identification numbers are not intentionally tampered with or accidentally changed once the card is created. On the other hand, it may be desirable that some data stored on the identification tag be erased and rewritten. In such embodiments, at least a portion of the memory location in the identification tags could be rewriteable and the tags may later be processed again through a similar device for updating the saved information. In these embodiments, the memory may be configured with a portion as write-once space for storage of the identification number and a portion as rewritable for storage of other information.

Referring to FIGS. 12-14, a further embodiment of an identification tag according to the present invention may include a forming or molding process involving a strip substrate onto which are positioned various components of the tag. Such a strip substrate 100 is shown in FIG. 12. Substrate 100 includes a plurality of mounting locations 102 onto which are positioned the components of a tag in a desired order (which will be described further below). To begin forming a tag, substrate 100 is extended into a tag production device 104, which may be a single enclosed machine or which may be composed of a plurality of individual machines performing one or more but not all of the constituent processes.

A first mounting location 102 is positioned within device 104 so one or more wires or circuits 106 may be formed onto substrate 100. Circuits 106 may include a first lead 108, a coil 110, and a second lead 112. A chip 114 may be positioned and electrically connected to leads 108 and 112. In certain embodiments, a battery 109 also can be laid onto the substrate 100 within the coil 110 and electrically connected to the chip 114 and the coil 110.

Coil 110 is preferably composed of a plurality of windings of an electrically conductive wire, and may serve as both an induction coil and a transmission antenna, as described above. A secondary antenna may also be laid onto substrate 100 at location 102, such as within coil 110 as shown in the FIGS., above. Alternatively, coil 110 may serve as both high and low frequency transmission antenna, so that secondary antenna is not needed. As a further alternative, the secondary antenna could be located outside of coil 110 and still electrically connected to chip 114.

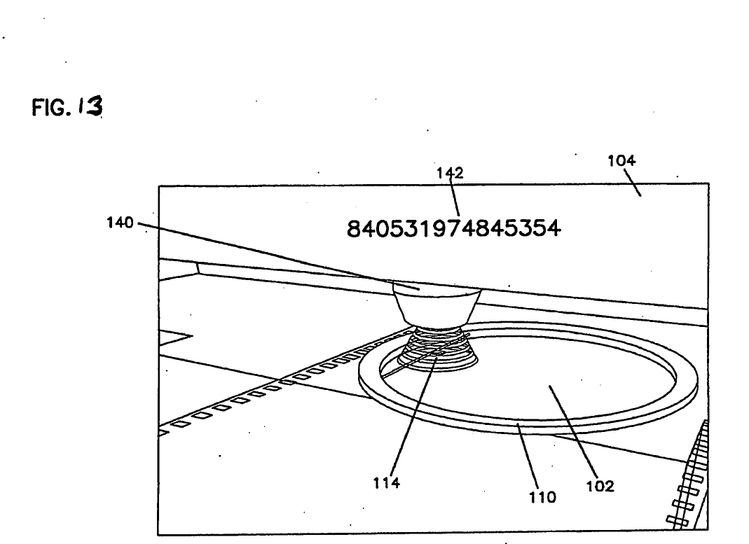

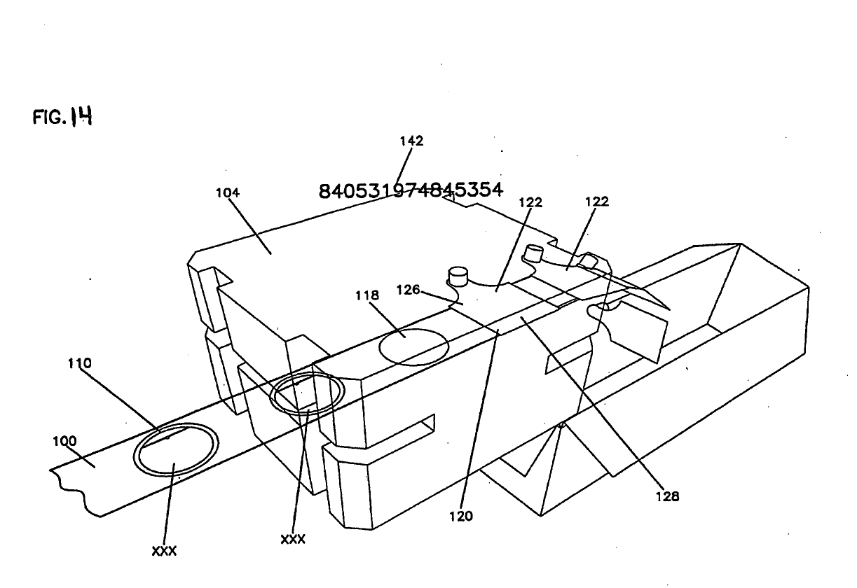

In certain embodiments, the device 104 may include a data write head 140 (FIG. 13) to digitally encode a unique identifier 142 into chip 114, as shown in FIG. 8. Typically, the data write head 140 encodes the identifier 142 after the coil 110, leads 108 and 112, battery 109, and chip 114 have been positioned on substrate 100 at a position 102.

It is desirable that device 104 be configured to perform a dual mold operation, such as illustrated in FIG. 14. In a dual mold operation, a first molded material 118 is placed at location 102 about coil 110, chip 114, battery 109, and leads 108 and 112. First molded material 118 is sized to encase the earlier placed components in a relatively less flexible and more durable material, which can help maintain the integrity of the components and the connections between the components. However, as it is desirable to have a flexible tag to attach to the animal to be identified, the entire tag is preferably not molded of this relatively less flexible material. In a second molding process within device 104, a second, more flexible molded material 120 is placed about and encases first molded material 118. Second material 120 preferable forms the finished size and shape of a tag 122.

Substrate 100 can be made of any of a variety of materials of sufficient strength and flexibility to provide a workable tag. Suitable materials include polyurethane, or similar flexible materials. It is anticipated that substrate 100 and tag 122 can include or be made of any of a wide variety of thermoactive materials. Numerous suitable thermoactive materials are commercially available.

Suitable thermoactive materials include thermoplastic, thermoset material, a resin and adhesive polymer, or the like. As used herein, the term “thermoplastic” refers to a plastic that can once hardened be melted and reset. As used herein, the term “thermoset” material refers to a material (e.g., plastic) that once hardened cannot readily be melted and reset. As used herein, the phrase “resin and adhesive polymer” refers to more reactive or more highly polar polymers than thermoplastic and thermoset materials.

Suitable thermoplastics include polyamide, polyolefin (e.g., polyethylene, polypropylene, poly(ethylene-copropylene), poly(ethylene-coalphaolefin), polybutene, polyvinyl chloride, acrylate, acetate, and the like), polystyrenes (e.g., polystyrene homopolymers, polystyrene copolymers, polystyrene terpolymers, and styrene acrylonitrile (SAN) polymers), polysulfone, halogenated polymers (e.g., polyvinyl chloride, polyvinylidene chloride, polycarbonate, or the like, copolymers and mixtures of these materials, and the like. Suitable vinyl polymers include those produced by homopolymerization, copolymerization, terpolymerization, and like methods. Suitable homopolymers include polyolefins such as polyethylene, polypropylene, poly-1-butene, etc., polyvinylchloride, polyacrylate, substituted polyacrylate, polymethacrylate, polymethylmethacrylate, copolymers and mixtures of these materials, and the like. Suitable copolymers of alpha-olefins include ethylene-propylene copolymers, ethylene-hexylene copolymers, ethylene-methacrylate copolymers, ethylene-methacrylate copolymers, copolymers and mixtures of these materials, and the like. In certain embodiments, suitable thermoplastics include polypropylene (PP), polyethylene (PE), and polyvinyl chloride (PVC), copolymers and mixtures of these materials, and the like. In certain embodiments, suitable thermoplastics include polyethylene, polypropylene, polyvinyl chloride (PVC), low density polyethylene (LDPE), copoly-ethylene-vinyl acetate, copolymers and mixtures of these materials, and the like.

Suitable thermoset materials include epoxy materials, melamine materials, copolymers and mixtures of these materials, and the like. In certain embodiments, suitable thermoset materials include epoxy materials and melamine materials. In certain embodiments, suitable thermoset materials include epichlorohydrin, bisphenol A, diglycidyl ether of 1,4-butanediol, diglycidyl ether of neopentyl glycol, diglycidyl ether of cyclohexanedimethanol, aliphatic; aromatic amine hardening agents, such as triethylenetetraamine, ethylenediamine, N-cocoalkyltrimethylenediamine, isophoronediamine, diethyltoluenediamine, tris(dimethylaminomethylphe-nol); carboxylic acid anhydrides such as methyltetrahydrophthalic anhydride, hexahydrophthalic anhydride, maleic anhydride, polyazelaic polyanhydride and phthalic anhydride, mixtures of these materials, and the like.

Suitable resin and adhesive polymer materials include resins such as condensation polymeric materials, vinyl polymeric materials, and alloys thereof. Suitable resin and adhesive polymer materials include polyesters (e.g., polyethylene terephthalate, polybutylene terephthalate, and the like), methyl diisocyanate (urethane or MDI), organic isocyanide, aromatic isocyanide, phenolic polymers, urea based polymers, copolymers and mixtures of these materials, and the like. Suitable resin materials include acrylonitrile-butadiene-styrene (ABS), polyacetyl resins, polyacrylic resins, fluorocarbon resins, nylon, phenoxy resins, polybutylene resins, polyarylether such as polyphenylether, polyphenylsulfide materials, polycarbonate materials, chlorinated polyether resins, polyethersulfone resins, polyphenylene oxide resins, polysulfone resins, polyimide resins, thermoplastic urethane elastomers, copolymers and mixtures of these materials, and the like. In certain embodiments, suitable resin and adhesive polymer materials include polyester, methyl diisocyanate (urethane or MDI), phenolic polymers, urea based polymers, and the like.

Suitable thermoactive materials include polymers derived from renewable resources, such as polymers including polylactic acid (PLA) and a class of polymers known as polyhydroxyalkanoates (PHA). PHA polymers include polyhydroxybutyrates (PHB), polyhydroxyvalerates (PHV), and polyhydroxybutyrate-hydroxyvalerate copolymers (PHBV), polycaprolactone (PCL) (i.e. TONE), polyesteramides (i.e. BAK), a modified polyethylene terephthalate (PET) (i.e. BIOMAX), and “aliphatic-aromatic” copolymers (i.e. ECOFLEX and EASTAR BIO), mixtures of these materials and the like.

Whatever material is used for substrate 100, the material should compatible with first and second molded materials 118 and 120. This will ensure good adhesion of the material once they are molded together to form tag 122. It may be preferable to have substrate 100 and molded materials 118 and 120 be made from different forms, durometer or hardness of the same base material, such as polyurethane. Such a common material base for all three components may help to improve bonding of the materials of tag 122. Another approach to improving bonding or adhesion between the materials may be to mold second material 120 about first material 118 while first material 118 is still green, meaning that is has not fully cooled or cured. These approaches to improved bonding or adhesion may be applied separately in the formation of tag 122 or may be combined.

As described above, tag 122 may be printed upon in a later process with various unique identification numbers and other unique visual attributes. However, such printed markings may be susceptible to damage if they are surface markings only. Device 104 may be configured to mold in a unique identification number in an exterior surface of second material 120. Such a molded in marking 126 is less susceptible to destruction during movement of a tagged animal. Such a molding-in process within device 104 may be carried out with a mold imprint that is automatically indexed for each tag 122 produced along substrate 100, so that each tag 122 has a unique identifier compared to the other tags of the substrate. If sets of numbers are provided by an appropriate government agency, the molded in numbers can be made to correspond to or match some or all of the government issued numbers. Tag 122 may also include an area 128 for adding a local or management identifier separate from the government issued identifier.

As an alternative, or in addition, to the identifier molding process described above, the device 104 may also include an inkjet printer head, a laser printer head, or some form of a sublimation printer head. These different printer heads within device 104 would provide for different levels of permanence and durability of markings as compared with the molding process. The print head can be employed to print, for example, the date and time that the tag is being printed or that the animal arrived at or departed from the facility. It is also anticipated that different in-mold decorating processes may be used to mark tag 122 with unique government identifier 142. Also, other methods may be used to provide additional security for the authenticity of tag 122, such as heat stamping holograms or similar features into tag 122 during the placement of second material 120 within the mold.

In-mold marking or labeling may be incorporated with the present disclosure to provide an alternative approach to forming tags 122 with distinct visual appearances. Such in-mold marking may include the insertion of a pre-printed mold-sized substrate within the mold and adhered to an inner surface of the mold. When second material 120 is injected into the mold, the pre-printed substrate and second material 120 would fuse or bond, durably attaching marking to the exterior of tag 122 during the molding process. As alternative, substrate 100 may be used to incorporate a pre-printed exterior marking, for example, on a reverse side opposite where the antenna is formed, and device 104 configured to ensure that this reverse side of substrate 100 is part of an outer surface of tag 122.

Depending on the requirements of the particular application, device 104 may provide tags 122 with unique government identifier 142 and one or more local indicia, such as color coding, or larger printed identifiers such as, but not limited to local or management numbers 146. Such a combination of government issued identifier 142 and local management number 146 would permit tag 122 to fulfill both higher level tracking and long term functions along with shorter term local functions, such as tracking an animal in a feedlot or an auction facility. The local indicia can include, for example, the date and time that the tag is being printed or that the animal arrived at or departed from the facility.

As described above, tag 122 is shown with a single chip 114 mounted to substrate 100. In this embodiment, chip 114 is capable of handling both high and low frequency transmission. It is also anticipated that two separate chips may be mounted within each tag 122. One of the chips may manage the receipt of power induced by an external signal received through coil 110, the portioning of none, some, or all of the power to the battery 109, and then the transmission of one of the two transmission frequencies. The first chip could also pass some of the induced energy from the coil 110 to the second chip. The second chip may then transmit on the second frequency. It may be desirable to use two separate chips to reduce overall cost of production or to improve efficiency of the transmission or reception functions of tag 122. Alternatively, using two chips may enable more flexibility in the use of alternative embodiments of tags, as will be described below.

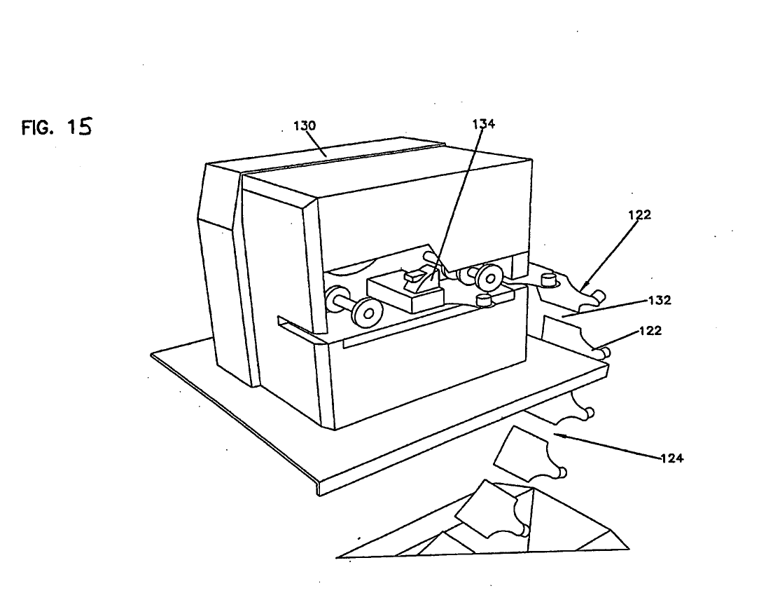

As shown in FIG. 15, a string of tags 122 formed on substrate 100 is maintained in a continuous strip 124, which may be fanfolded, rolled or otherwise packaged for sending to a producer, an auction lot, or other location within the animal production process. In an embodiment, tags 122 in strip 124 are inserted within a printing and encoding device 130 that may be positioned chute or corral side for ease of operation. Each of the tags 122 is pre-molded and encoded with a government issued identifier. Each of the tags 122 also includes area 128 for printing, embossing or otherwise marking with a local or management identifier. Area 128 allows a printing head 134 of chute side printer and encoder 130 to be used to apply a specific marking immediately prior to tag 122 being attached to the animal. While a novel printer/encoder embodiment 130 is described and shown herein, it is anticipated that tags 122 and strip 124 may be used with conventional printers currently in use for printing characters or symbols within area 128.

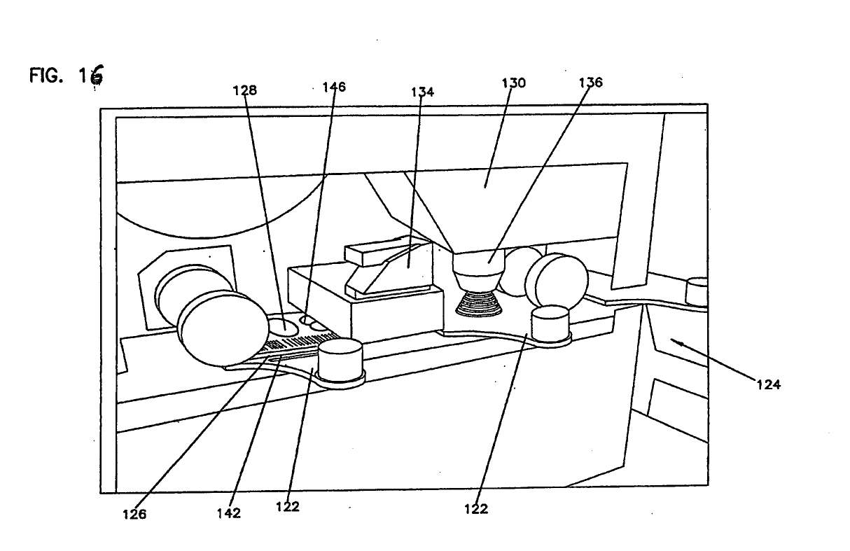

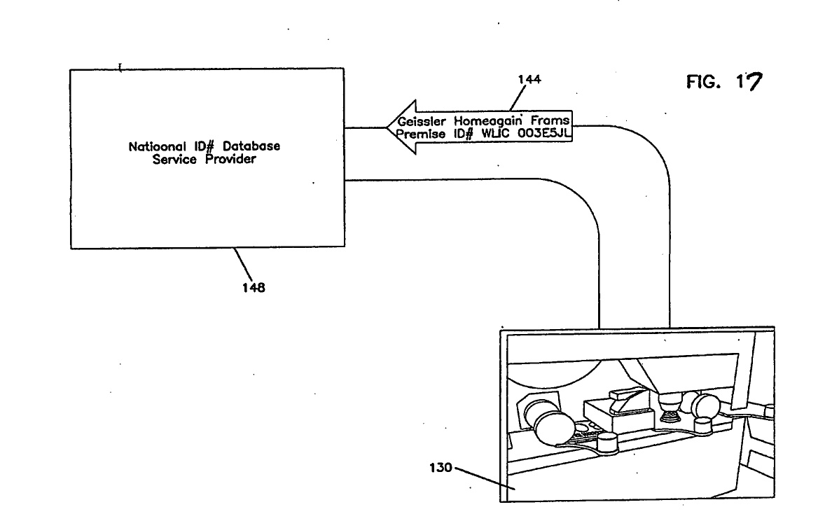

As shown in FIG. 16, a chute side printer and encoder 130 may also include an encoding head 136 to place additional digital information on chip 114. The additional information can be transmitted at a higher frequency when the tag 122 is queried with an appropriate signal. As shown also in FIG. 17, such additional information 144 could include identifiers of the producer premises, relevant dates, local control numbers or other elements. As further shown in FIG. 17, chute side printer and encoder 130 may also upload certain information to a national database 148 to associate a particular government identifier 142 with particular additional information 144.

By having tags 122 maintained in a strip 124, printer 130 may advance tags 122 automatically without requiring a user to manually insert tags. After each tag 122 is printed with a local management number 146 in print area 128, a web 132 between each tag 122 may be severed by a final operation of printer 130, and a user may retrieve the tag for attaching to the animal. Having tags 122 in a specific order along strip 124 ensures that a known sequence of government identifiers may be assigned to animals.

As described above, one of the unique features of a radio frequency identification tag of the present invention is the inclusion of two distinct transmission frequencies. In addition, these two frequencies may be provided to communicate different sets of data and they may function at different ranges or proximities to a transceiver keyed to induce power into coil 110.

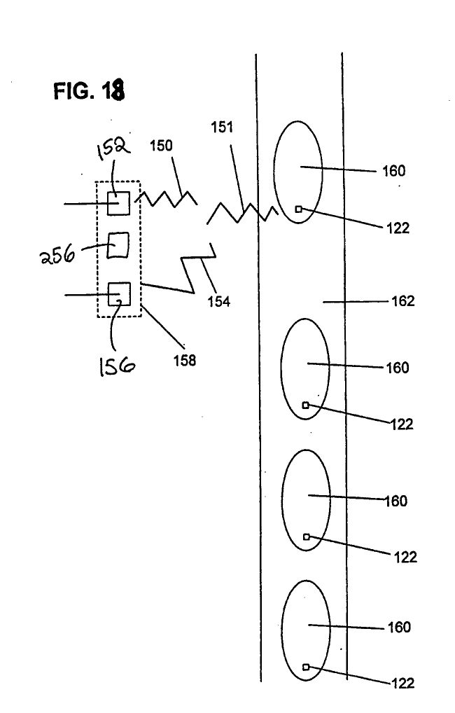

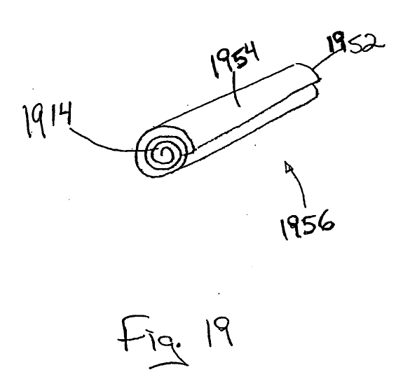

Referring to FIG. 18, differences in frequency may also be configured to provide different depths of penetration as balanced with signal or data density or transmission speed. For example, a lower frequency signal, such as query signal 150 and reply signal 151 will be able to penetrate through relatively more material but will have relatively shorter range of transmission to an external transceiver 152, as shown in FIG. 18. Such a lower frequency signal will also be able to transmit relatively less data over time. A higher frequency signal 154 will provide a greater transmission distance if the range is unobstructed, though signal 154 will not be able to penetrate an obstruction as well as signal 150. Further, signal 154 will be able to transmit a greater amount of data over the same amount of time to a receiver 156, as compared to signal 150.

However, since there is growing acceptance of a standard, or ISO frequency for use with agricultural animals, such as cattle, at least one of the frequencies transmitted by tag 122 preferably conforms to the standard. The second, or any additional frequencies, may be configured as desired by a user or producer to accomplish other herd management or sales tasks. For example, a producer may desire to have ear tags on cattle which transmit a government issued identification number to a standard transceiver and also transmit more specific information such as date of birth, or more specific herd information, to specialized receiver. The government identifier is likely a required item that must be transmitted by tag 122, while the remaining data items are for specific herd or sales functions.

In the previous examples of printing and encoding of tags, described above, the tag was printed and encoded with all data and identifiers directly at chute side or in a single process. An alternative embodiment may involve two processes, one process for the creation of strip 124 of tags 122, each pre-encoded with a government identifier and indelibly marked with the identifier, and the other process for the printing and encoding local management data and identifiers. It is anticipated that the first process may be performed in a high efficiency and secure setting, which may be centralized and serve a plurality of producers and auction lots. The second process may take place at a user location, such as chute side at an auction yard or at a producer's premises.

By having coil 110 optimized for use with a standardized ISO frequency, which is typically approximately 134.2 kHz, the induction coil can be used to provide power to both of the high and low speed transmission circuits. Alternatively, one or both of the high and low speed transmission circuits can obtain power from the battery 109, which obtains power from the induction coil 110. Tags are generally arranged to receive a signal with coil 110 at the same frequency that they transmit through coil 110. In one embodiment, the tag 122 can be configured so that power from the coil 110 or the battery 109 energizes both transmission circuits at the same time. Thus, the higher frequency transmission capability of tag 122 does not require a separate coil 110 and the high frequency receiver 156 receiving the higher frequency data signal from tag 122 does not require a transmitter. Alternatively, the transceiver 152 may include a receiver 156 within an integral housing such as housing 158, so that a single unit may receive both the low and high frequency signals 150 and 154 (see FIG. 18).

Another advantage to using two different frequencies for transmitting data from tag 122 is that it allows more information to be gathered from animals 160 that may be moving quickly, for example, along a passageway or chute 162 between pens or other holding enclosures. With the lower frequency signal 150, the animal may be within range of transceiver 152 for only a short time, allowing only the simple government identifier to be transmitted and received, before the animal has moved out of range. The paired use of higher frequency signal 154, with a proportionally longer range and a greater transmission speed, may provide a longer dwell time of the animal within the range of receiver 156 and provide for the transmission of more detailed data during this dwell time. Both of these frequencies, with their different ranges and transmission speed, are examples of near-field communications approaches and some of the trade-offs that may exist with such approaches. The pairing of complementary near-field communications systems within a single tag 122 provides for a balancing of the tradeoffs without sacrificing conformance with a required standard or speed and density of data transmission.

As shown in FIG. 18, more than one animal 160 may be within range of either or both transceiver 152 and receiver 156 simultaneously. They may be within chute 162, a holding pen or corral, or some other enclosure. When this occurs, a plurality of tags 122 may be trying to respond to query signal 150, so that a plurality of signals 151 and 154 may be transmitted at the same time. In such a situation, some form of anti-collision mechanism is desirable to reduce conflicts or collisions among the plurality of signals 151 and 154 being transmitted by the plurality of tags 122 so that each of the signals 151 and 154 can be captured by transceiver 152.

One embodiment of an anti-collision approach is to include a switch in the higher frequency transmission portions of circuitry 106 of tags 122 and to configure a second transceiver 256 in addition to or in place of receiver 156. Such a switch, preferably included on chip 114, would permit transceiver 256 to signal to each tag in turn when it has received the additional information 144 from that particular tag 122. When a tag 122 receives this acknowledgement signal from second transceiver 256, the tag 122 would cease to transmit its additional information 144. This will permit transceiver 256 to receive and acknowledge in turn the receipt of the additional information 144 from each tag 122, until all the tags 122 within range of transceiver 256 have ceased to transmit high frequency signals.

Such anti-collision technology could also be applied to the lower frequency transmission by tags 122 but is less likely to be needed, due to the shorter range of the lower frequency transmissions. In addition, it may be desirable to ensure that tag 122 always transmits its government identifier when polled by transceiver 152.

As shown in the earlier FIGS., different antennas for each of the different frequencies may be provided within tag 122. One of the transmission antennas is shown as the same coil 110 that receives an induction and polling signal to trigger energy storage and/or signal transmission by tag 122. It is anticipated that tag 122 may include a single transmission antenna that serves both frequencies, with coil 110 serving only as a receiving antenna. Also, the antennas shown have been generally planar layout, lying generally parallel with tag 122. Such an antenna layout transmits most efficiently in a direction perpendicular to the plane of tag 122. However, it is difficult to ensure that tag 122 will be optimally positioned by the marked animal to place the tag in the desired plane. It is anticipated that one or both transmission antennas may be configured to be more omni-directional, and thus may provide a stronger signal in one or both frequencies along a broader range of directions.

It is also anticipated that the above dual process creation of animal identification tags may be adapted to non-electronic identifier tags. As an example, it is known to provide animals with temporary back tags once they arrive at an auction lot from a producer facility. These back tags include basic identification of the animals and their source during and immediately after the auction but are not intended to be permanently attached to the animal. Such tags may still be created with a government issued identifier at a central facility and shipped to the auction lot for chute side printing with the desired local identifiers and source information that are necessary for the sale to proceed. Such tags might only last for a week or so, but this may be sufficient time for an animal to pass from a producer through an auction lot, to a buyer, who immediately processes the animal. The government identifier would accompany the animal during these transitional steps between the various parties and be available to the processor to ensure that a source identifier remains with the animal. While not having the benefit of the remote query and transmission capabilities described above, this temporary tagging production process may satisfy regulatory requirements for identification of source throughout the transfer and processing functions.

Similarly, it is anticipated that an alternative embodiment of tag 122 may be constructed without the electronics for receiving or transmitting signals. This alternative non-electronic tag could still be created in a continuous strip upon substrate 100 and pre-printed with a unique government identifier through a variety of in-mold or post molding labeling techniques described above. The tag could then be transported chute-side, where a local identifier and/or additional information regarding the animal, such as source, date of birth, etc, may be printed on the tag before it is affixed to the animal.

It is also anticipated that back tags may be formed according to the present invention which incorporate one or more of the signaling features described above. Such RFID back tags may be configured similarly to tag 122 or other tags described above, and include antenna(s) and circuitry for receiving a signal at a first frequency, storing energy obtained from the signal, and responding with a signal at one or more frequencies. Such RFID back tags would not need to be encapsulated in a durable outer layer, such as second material 120, as the back tags are not intended to be present on the animal or object marked for an extended period of time.

It may be desirable to have these back tags include first material 118 as a more durable, more rigid layer than current back tags, to provide some degree of integrity protection for the antenna and circuitry as the tag is attached to the back of an animal and the animal wanders about a corral or pen at a sales or holding facility. The antenna, battery, and signal circuitry could be mounted to substrate 100 and then overmolded with first material 118, as described above. The combination can be marked in-mold or printed on post molding to provide the external markings described above. This external printing may be accomplished wholly or in part at chute-side. As described above, these RFID back tags may be encoded wholly or in part at chute-side as well.

### A Flexible Tag, Method, and System

A flexible and/or implantable identification tag for an animal can include an antenna, a first circuit including a memory subunit, a power subunit, and a first transmit subunit. The subunits are electrically connected to each other. The power subunit of the first circuit is configured to generate an electrical current when a radio signal is received by the antenna, and to deliver this current to the first transmit subunit. The first transmit subunit is configured to transmit a first signal at a first frequency when it receives electrical current from the power subunit. The first signal encodes at least a first portion of any data within the memory subunit.

In an embodiment, the flexible and/or implantable tag also can include a second circuit including a second transmit subunit. The second circuit is electrically connected to the first circuit. An antenna is connected to the first circuit. The second circuit is configured to transmit a second signal at a second frequency when it receives electrical current from the power subunit. The second signal encodes at least a second portion of any data within the memory subunit.

In certain embodiments, the flexible and/or implantable animal identification tag includes a flexible substrate. A processor and an antenna can be coupled to the flexible substrate. The processor can include data memory storage, power circuitry, and transmission circuitry. The power circuitry is configured to generate electrical current when a first radio signal at a first frequency is received by the antenna. The transmission circuitry is configured to transmit at least a portion of any data within the data memory storage at a second frequency when electrical current is received from the power circuitry.

In an embodiment, the antenna can be embossed or printed on the flexible substrate. The antenna can be flexible, such that the antenna remains intact when the flexible substrate is altered from a flat configuration to, for example, a rolled configuration. Suitable antenna structures include those found on anti-theft or tracking devices configured for adhering to a cover of a book, for example, a library book. The antenna can include or be composed of a conductive material, such as silver. The antenna can be configured on the flexible substrate for effective reception of electromagnetic energy of the desired frequency when the substrate is rolled up. In such a configuration, the antenna can effectively provide energy to the processor. The conductive material can be applied to the flexible substrate by, for example, lithography, “ink-jet” type printing, stamping, sputtering, or the like.

In some embodiments, the flexible and/or implantable tag also can include a flexible battery. In an embodiment, power from the flexible battery can be used to obtain data from the data memory storage. In an embodiment, power from the flexible battery can be used to transmit the obtained data. In an embodiment, the flexible battery can be printed on a flexible substrate.

In an embodiment, the processor is sized to effectively roll up in a rolled flexible substrate. A suitable processor can have a generally square or rectangular flat solid about 3 mil on its longest side or across a diagonal. In an embodiment, a suitable processor can roll up in the rolled flexible substrate without enlarging the diameter of the rolled substrate compared to the rolled flexible substrate including the antenna but not the processor. In an embodiment, the processor is positioned on the flexible substrate to be rolled in an outer or outermost layer of the rolled substrate. In an embodiment, the processor is positioned on the flexible substrate to be rolled in an inner or innermost layer of the rolled substrate. The processor is constructed to operate in the rolled flexible substrate.

In an embodiment, the processor and antenna are coupled to the flexible substrate and sealed from the surroundings by a wrap. In an embodiment, the wrap is made from or includes a polymer, such as a biocompatible polymer. For example, the wrap can be composed of a parylene. In an embodiment, the wrap is disposed on one or more sides of the flexible substrate. In another embodiment, the wrap envelopes the flexible substrate. Sealing the processor and antenna from surroundings inhibits fluids, such as biological fluids, from penetrating the wrap and disabling or shortening the life of the RFID system.

The present flexible and/or implantable animal identification tag can be configured to provide a generally cylindrical roll dimensioned to fit in the cannula of a needle or catheter. For example, the rolled system can be generally cylindrical and have a diameter allowing it to fit in a 12 gauge needle, in a 10 gauge needle, in an 8 gauge needle, or the like. For example, the rolled system can be generally cylindrical and have a diameter less than or equal to 2 mm, 1 mm, or 0.5 mm.

The present invention includes an animal and a tag implanted in the animal according to the present invention. In certain embodiments, the flexible tag can include a variety of the embodiments described hereinabove of, for example, circuitry, data, or indicia. In certain embodiments, the flexible tag can be made by any of a variety of the embodiments of the methods described hereinabove.

### Illustrated Embodiments of the Flexible Tag

FIG. 19 schematically illustrates an embodiment of identification tag 14 (FIG. 1) in a rolled configuration, i.e. rolled identification tag 1956. In the embodiment schematically illustrated in FIG. 19, the identification tag 1914 includes flexible substrate 1954, which can be rolled to produce rolled identification tag 1956. The identification tag 1914 includes seal 1952. The seal 1952 isolates components (e.g., wire loop antenna 20 and chip 22) of the identification tag 1914 from the surroundings of the tag 1914. Seal 1952 can be in the form of a layer of biocompatible polymer applied on and surrounding identification tag 1914. Seal 1952 can be composed of a polymer such as a parylene.

In other embodiments, however, any of the above described embodiments of identification tags can be wrapped in a rolled configuration similar to rolled identification tag 1956. For example, duel frequency tag 34 also can be arranged on a flexible substrate and wrapped into a rolled configuration.

### Illustrated Embodiments of Dairy Tag, System, and Method

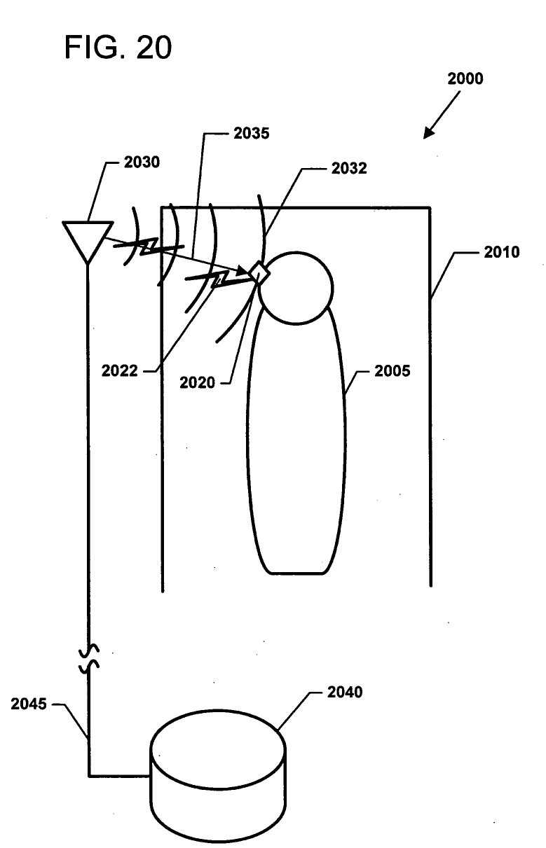

FIG. 20 illustrates an animal tracking system 2000 for dairy applications. The animal tracking system 2000 includes a rechargeable identification tag 2020 coupled to an animal 2005. For example, in an embodiment, the rechargeable tag 2020 includes the transponder 214 of FIG. 3. In another embodiment, the rechargeable tag 2020 includes the transponder 314 of FIG. 7. In other embodiments, the rechargeable tag 2020 includes a rechargeable power source, an antenna, and a data store.

In some embodiments, the rechargeable tag 2020 can be mounted through an ear or other appendage of the animal 2005. In other embodiments, the rechargeable tag 2020 can be implanted inside the body of the animal 2005 (e.g., via injection or surgery). In other embodiments, the rechargeable tag 2020 can be hung around the neck of the animal 2005 or fastened to a collar or other article worn by the animal 2005. In one embodiment, the animal 2005 is a dairy cow. In other embodiments, however, the animal 2005 can be any suitable animal to be tracked.

The tracking system 2000 also includes a data manager interface 2030 operably positioned at a location 2010 the animal 2005 is expected to visit. For example, the location 2010 can include a dairy milking stall. In other embodiments, the location 2010 also can include a pen, a food trough, a water trough, a saltlick, a wind break, a sty, a fence, a gate, a chute, a door, a building wall, or any other such location. In general, the data manager interface 2030 includes an antenna configured to communicate with the identification tag 2020. In an embodiment, the data manager interface 2030 includes a low frequency antenna.

When the animal 2005 approaches this location, the tag 2020 on the animal sends a status update transmission 2022 to the data manager interface 2030. In some embodiments, the tag 2020 periodically transmits the status update 2022. In an embodiment, the tag 2020 continuously transmits the status update 2022. In another embodiment, the data manager interface 2030 prompts the tag 2020 to initiate the status update transmission 2022 by sending out a status update query signal 2032. For example, the data manager interface 2030 can send out query signals 2032 continuously or at periodic intervals. When the tag 2020 receives the query signal 2032, the tag 2020 fully activates, accesses its memory, and transmits status data stored in the memory to the data manager interface 2030.

The data manager interface 2030 also can provide power to the tag 2020. In an embodiment, the data manager interface 2030 provides power to the tag 2020 via the query signal 2032. In another embodiment, the data manager interface 2030 provides power to the tag 2020 via a separate power transmission signal. In general, the data manager interface 2030 provides at least sufficient power to activate the tag 2020 and to enable transmission of the status update 2022 to the data manager interface 2030. In some embodiments, the data manager interface 2030 provides power beyond that necessary to process and transmit the status update 2022. That excess power can be stored by the tag 2020 for later use. For example, the excess power can be stored in a power store on the tag 2020. In an embodiment, the power store on the tag 2020 is a rechargeable battery. In another embodiment, the power store on the tag 2020 is a supercapacitor.

In some embodiments, the data manager interface 2030 continuously provides a fixed amount of power to the tag 2020 for as long as the tag 2020 remains in range 2035 of the data manager interface 2030. In other embodiments, the data manager interface 2030 varies the amount of power being sent to the tag 2020 over time. For example, in some embodiments, the data manager interface 2030 can increase or decrease the amount of power being sent based on the status update transmission 2022 or a subsequent power level feedback transmission from the tag 2020.

In some embodiments, the status update transmission 2022 from the tag 2020 includes an identification number assigned to the tag 2020 identifying the animal to which the tag 2020 is coupled. In an embodiment, the status update transmission 2022 includes a location log indicating when the tag 2020 has previously checked in with the data manager interface 2030 or other antennae. In an embodiment, the status update transmission 2022 includes information indicating any processing and/or transaction errors that have occurred. In other embodiments, the status update transmission 2022 can include a medical history, ownership history, or other such information about the animal to which the tag 2020 is coupled.

In an embodiment, the tag 2020 updates its proximity status log by incrementing a counter if the tag 2020 determines the tag 2020 is located in proximity to the data manager interface 2030. In an embodiment, the tag 2020 logs its proximity status by recording a number of separate visits to the data manager interface 2030 (i.e., a number of times the tag 2020 has entered and exited a range of the data manager interface 2030). In an embodiment, the tag 2020 logs its proximity status by recording dates and times of each visit to the data manager interface 2030. In an embodiment, the tag 2020 logs its proximity status by recording the length of time of one or more visits to the data manager interface 2030.

The data manager interface 2030 reports the proximity status of the tag 2020 to a data storage manager 2040 for analysis and/or storage (e.g., long-term storage, secure storage, network storage, etc.). The data storage manager 2040 can receive and manage information obtained from multiple tags 2020 within the tracking system 2000. The data manager interface 2030 is connected to the data storage manager 2040 via connection line 2045. In an embodiment, the connection line 2045 includes a cable connection. In another embodiment, the connection line 2045 includes a wireless connection. In another embodiment, the connection line 2045 includes a network connection.

In an embodiment, the data manager interface 2030 polls for information from one or more surrounding tags 2020. For example, the antenna 2030 may broadcast a query signal 2032 within a range 2035 of the antenna of the data manager interface 2030. In another embodiment, the data manager interface 2030 receives unsolicited status reports from tags 2020. The data storage manager 2040 may store one or more applications that use the proximity status information obtained from the animal tag 2020 and data manager interface 2030. In some embodiments, the animal tag 2020 and the data manager interface 2030 are configured to transmit radio signals. In an embodiment, the components of the management system 2000 communicate via packet framing. In other embodiments, however, another communications protocol may be used.

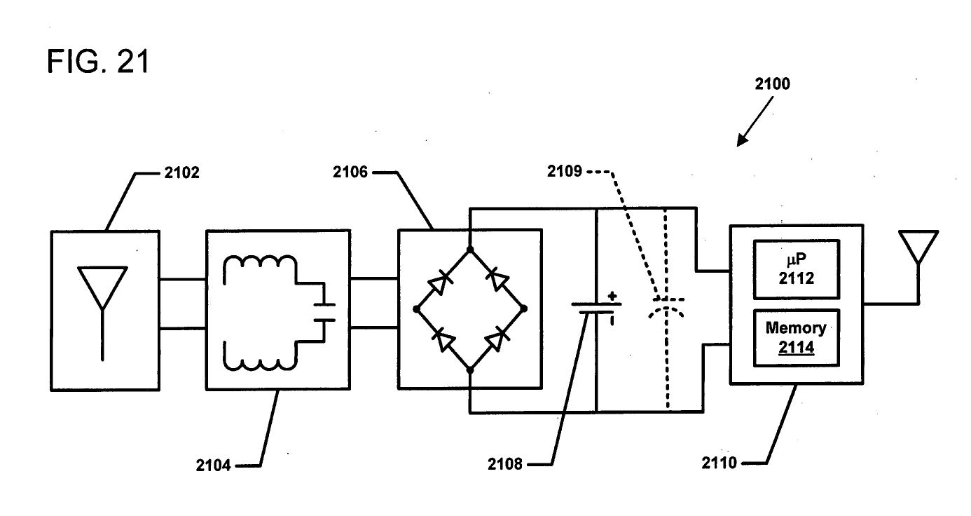

FIG. 21 is a schematic diagram of an electrical circuit arrangement 2100 that can be used to implement the identification tag 2020 of FIG. 20. The electrical circuit 2100 includes a first antenna 2102, a frequency matching circuit 2104, a diode bridge 2106, a power store, and a control circuit 2110. In an embodiment, the power store includes a battery 2108. In another embodiment, the power store includes a supercapacitor 2109 (shown in dotted lines). The control circuit 2110 includes a microprocessor 2112 and a memory store 2114. The arrangement 2100 shown in FIG. 21 is non-limiting and other electrical circuitry can be included in the circuit arrangement 2100 as appropriate. For example, other embodiments of the identification tag 2020 can omit the frequency matching circuit 2104, can include multiple power stores, and/or can include multiple control circuits.

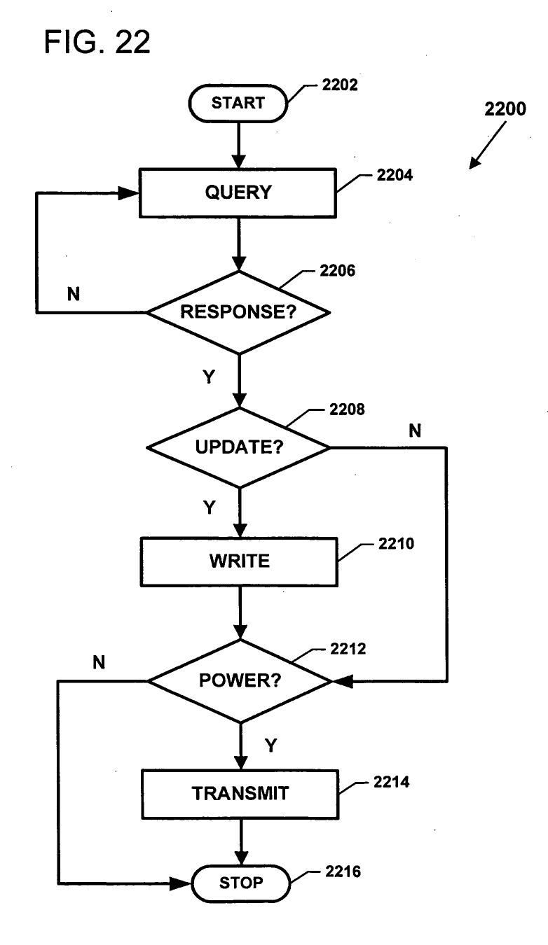

FIG. 22 is a flowchart illustrating an operational flow for an example exchange process 2200 by which a power store of an identification tag can be recharged. For example, the data manager interface 2030 of tracking system 2000 can use the exchange process 2200 to recharge the identification tag 2020 of FIG. 20. In an embodiment, data (e.g., a status update) also can be provided from the data manager interface to the identification tag 2020 during the exchange process 2200.

The exchange process 2200 begins at a start module 2202, implements any appropriate initialization procedures, and proceeds to a query operation 2204. The query operation 2204 transmits a query signal from a data manager interface to determine whether any identification tags are located within a range of the data manager interface. For example, the query operation 2204 can periodically transmit an electromagnetic signal from an antenna of the data manager interface. In general, the query signal transmitted by the data manager interface prompts any tag 2020 within range of the data manager interface to respond with an identification number stored on the tag 2020.

A response module 2206 determines whether the data manager interface 2030 has received a response from any identification tags 2020. In an embodiment, the response module 2206 determines whether any identification tag 2020 has modulated the query signal sent by the data manager interface. In another embodiment, the response module 2206 determines whether any identification tag has generated and transmitted radio waves carrying the response signal to the data manager interface. If no responses have been received, then the exchange process 2200 cycles back to the query operation 2204 to begin again. If a response has been received, however, then the exchange process 2200 proceeds to a determination module 2208.

The determination module 2208 determines whether any data should be uploaded to the identification tag 2020. In an embodiment, the determination module 2208 can determine whether the data manger 2240 contains any information to be stored on the identification tag 2020. For example, the determination module 2208 can determine whether the data manager 2240 contains updated medical records for the dairy cow to store on the tag 2020. In another embodiment, the data manager 2240 can update the proximity information on the identification tag 2020. In another embodiment, the data manager 2240 can update information indicating the amount of milk obtained from the animal during each visit, the amount of food and/or liquid consumed prior to the visit, the amount of sleep the animal had prior to the visit, mediation and/or vitamins the animal consumed prior to the visit, or other such information.

If the determination module 2208 determines information should be uploaded to the tag 2020, then the exchange process 2200 proceeds to a write operation 2210 that transmits the data to the identification tag 2020 for storage in the memory of the tag 2020. For example, the data manager interface can transmit a data signal to the tag 2020 after receiving the identification number of the tag in the response signal. In an embodiment, the data manager interface transmits information associated with the identification number of the identification tag. In another embodiment, the data manager interface transmits global information common to all identification tags 2020 in the system.

If the determination module 2208 determines that no information should be uploaded to the tag 2020, however, then the exchange process 2200 can proceed to an optional determination module 2212 to determine whether any additional power should be transmitted to the tag 2020. For example, in an embodiment, the optional determination module 2212 can process the response signal sent by the tag 2020 to determine a power level of the tag 2020. In another embodiment, the determination module 2212 can query the tag 2020 about the power level status of the tag, receive the power level status as a separate response, and make the determination based on the response.

If the determination module 2212 determines that additional power should be transmitted to the tag 2020, then the exchange process 2200 proceeds to a transmit operation 2214, which provides power to the tag 2020. For example, the transmit operation 2214 continues to transmit electromagnetic signals to the tag 2020. In an embodiment, the parameters of the signals transmitted by the data manger interface 2030 do not change between the query operation 2204 and the transmit operation 2214. In another embodiment, the signal transmitted by the data manager interface 2030 during the transmit operation 2214 has different parameters (e.g., a different amplitude and/or frequency) from the query signals.

In some embodiments, the data manager interface 2030 generates the power signal based on information provided by the tag 2020. For example, the data manager 2030 can produce a higher powered signal when the power store on the tag 2020 is less full and a lower powered signal when the power store on the tag 2020 is fuller. In an embodiment, the tag 2020 can request a power level of the power signal. The exchange process 2200 completes and ends at a stop module 2216.

In other embodiments, however, the data manager interface 2030 may not check with the tag 2020 prior to providing power. Instead, the data manager 2030 can transmit a signal carrying sufficient power to recharge the power store of the tag by a predetermined amount regardless of the status of the tag 2020. For example, in an embodiment, the data manager 2030 can transmit a signal carrying sufficient power to recharge the power store of the tag 2020 sufficient to power the tag for a predetermined period of time (e.g., an hour, a day, a week, a month, a year, etc.). In another embodiment, the data manager 2030 can transmit a signal carrying sufficient power to recharge the power store of the tag 2020 sufficient to power the tag for a predetermined number of transmissions (e.g., one transmission, ten transmissions, one hundred transmissions, two hundred transmissions, five hundred transmissions, etc.) of a given length (e.g., transmission lasting about 1 msec, about 5 msec, about 10 msec, about 25 msec, about 100 msec, etc.).

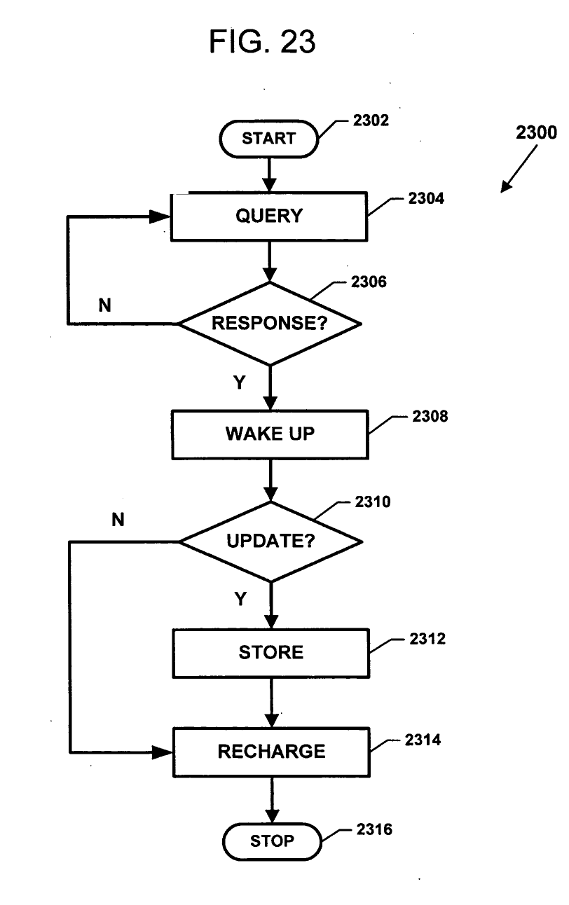

FIG. 23 is a flowchart illustrating an operational flow for another example exchange process 2300 by which a power store of an identification tag can be recharged. The exchange process 2300 shown in FIG. 23 is described as implemented by an identification tag. For example, the data tag 2020 of FIG. 20 can use the exchange process 2300 to recharge itself when within range of data manager interface 2030. In some embodiments, data (e.g., a status update, power feedback, etc.) also can be exchanged between the tag 2020 and the data manager interface 2030 during the exchange process 2300.

The exchange process 2300 begins at a start module 2302, implements any appropriate initialization procedures, and proceeds to a query operation 2304. The query operation 2304 transmits a query signal from the tag 2020 to determine whether the tag 2020 is within range of a data manager interface 2030. In an embodiment, the query signal includes an identification number stored on the tag 2020. In some embodiments, the tag 2020 transmits the query signal at periodic intervals (e.g., every few milliseconds, every few seconds, every few minutes, every few hours, etc.). In other embodiments, the tag 2020 transmits the query signal continuously.

A response module 23206 determines whether a response to the query signal has been received from a data manager interface 2030. The query operation 2304 is generally repeated until the response module 2306 determines a response has been received at the tag 2020. In other embodiments, however, the tag 2020 does not transmit a query signal. Rather, the tag 2020 can remain dormant until a query signal is received from a data manager interface when the tag 2020 comes within range of the data manager interface 2030.

When the tag 2020 determines it is located within range of a data manager interface 2030, a wake up operation 2308 activates the circuitry of the tag 2020 to enable the tag 2020 to access information stored in the memory of the tag 2020, edit the information, and/or write new information to memory. The wake up operation 2308 also transmits a current status of the identification tag 2020 to the data manager interface 2030. For example, the wake up operation 2308 can obtain information stored in memory on the tag 2020, can determine a level of power stored on the tag 2020, and/or can determine whether any operating errors have occurred for transmission to the data manager interface 2030 for processor and/or storage on the data manager 2040.

An update determination module 2310 determines whether any update information has been received from the data manager interface 2030. For example, the update determination module 2310 can determine if the tag 2020 has received any updated operating parameters, updated software, and/or updated information relating to the animal to which the tag 2020 is coupled. A store operation 2312 saves any received updates in the memory of the tag 2020.

A recharge operation 2314 stores the received power in a power store on the tag 2020. In some embodiments, the tag can determine a current power level contained in the power store of the identification tag 2020 and can transmit a power status to the data manager interface 2030. For example, in an embodiment, the tag 2020 can inform the data manager interface 2030 that sufficient power is stored on the tag. Accordingly, the data manager interface 2030 can terminate a power transmission to the tag 2020. In another embodiment, the tag 2020 can inform the data manager interface 2030 that additional power is needed. Accordingly, the data manger interface 2030 can continue to supply power to the tag 2020. In an embodiment, the data manager interface 2030 can increase the amount of power being supplied to the tag. The exchange process 2300 completes and ends at a stop module 2316.

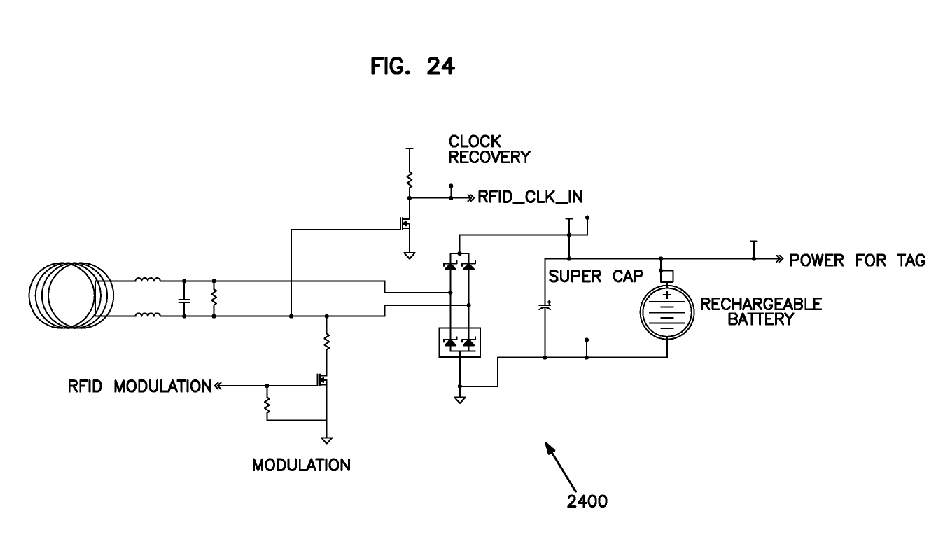

FIG. 24 is a circuit diagram showing an example recharging circuit 2400 that can be used by the tag 2020 to recharge the power store. In some embodiments, the power store is a supercapacitor. In some embodiments, the supercapacitor can be configured to hold between 1 and 100 millifarads of power. In an embodiment, the supercapcitor can hold about 47 millifarads of power. In other embodiments, the recharging circuit 2400 can store the power in a rechargeable battery.

The principles of the disclosure are further discussed in the following example application. Identification tags can be installed on dairy cows at a dairy farm. Each of these tags can include a processor, memory, antenna, and power store. The memory of the tag stores an identification number associated with the dairy cow to which the tag is attached. The memory of the tag also can store other information pertaining to the dairy cow. For example, the tag can store an ownership history of the dairy cow, a location history of the dairy cow, a medical history of the dairy cow, and/or a production history of the dairy cow.

A data manager interface can be installed at a milking station at which one or more of the dairy cows can be milked. The data manager interface includes an antenna for communicating with one or more of the identification tags. The data manager interface is communicatively coupled to the data manager (e.g., via a cabled connection, a network connection, a wireless connection, etc.). In some embodiments, one data manager interface can service multiple milking stations. In other embodiments, multiple data managers can be installed at the milking location.

Dairy cows typically undergo one to four milking sessions each day. The dairy cows remain at the dairy station for an extended period of time during each milking session. In general, each dairy cow spends about three hours or less at a milking station each day. For example, in an embodiment, a dairy cow can spend about thirty minutes at a milking station in one milking session. In another embodiment, a dairy cow can spend about one hour at a milking station in one milking session. In another embodiment, a dairy cow can spend about one and one half hours at a milking station in one milking session. In another embodiment, a dairy cow can spend about two hours at a milking station in one milking session. In another embodiment, a dairy cow can spend about ten minutes at a milking station in one milking session.

The identification tag can be programmed to toggle between a dormant state and an active state. When configured in the dormant state, the tag listens for signals broadcast by a data manager interface, a beacon, or another transmitter. When such signals are received, the tag wakes up (i.e., toggles to the active state) and transmits a response. For example, the tag can wake up, obtain its identification number from memory, and transmit an identification signal indicating its identification number. The tag also can transmit status information, such as information indicating an operating status of the tag, activities recorded by the tag since the last transmission, any errors that have occurred since the last transmission, etc. In other embodiments, the tag can perform other functions upon waking up. For example, the tag can check for signals being received from other transmitters,

In some embodiments, the tag wakes up at predetermined times regardless of whether such signals have been received. For example, the tag can be programmed to wake up and transmit an identification signal one or more times each hour. In an embodiment, the tag can be programmed to wake up and transmit the identification signal once an hour. In another embodiment, the tag can be programmed to wake up and transmit the identification signal once every half hour. In another embodiment, the tag can be programmed to wake up and transmit the identification signal every ten minutes. In another embodiment, the tag can be programmed to wake up and transmit the identification signal once a day. In another embodiment, the tag can be programmed to wake up and transmit the identification signal every few seconds.

The tag can harvest power from signals received from the data manager interface. In some embodiments, the tag harvests power from the data signals in which the data manager interface queries the tag or updates information stored on the tag. In other embodiments, the tag harvests power from a separate power signal broadcast by the data manager interface. In an embodiment, the tag harvests at least sufficient power to operate until the next scheduled milking session. In another embodiment, the tag harvests sufficient power to operate even if scheduled milking sessions are missed.

The amount of power that each tag can harvest during a milking session depends on the size of the antenna, the parameters of the signal being transmitted to the tag, and the length of time over which the signal is transmitted. These parameters can be adjusted to accommodate the size of the power store and/or the number of times the tag is to toggle to the active mode. Conversely, the size of the power store and/or the activation cycle of the tag can be accommodated to match the duration of the milking sessions for the dairy cows. Typically, the parameters are adjusted to enable the power store to recharge over a period of time on the order of minutes. In some embodiments, however, the parameters can be adjusted to enable recharging over a period of time on the order of one or more hours.

In one embodiment, the tag can harvest about 10 milliamps of current at about 3 volts for a total of about 30 milliwatts of power during a single milking session. This power is sufficient to enable one example tag, which has sufficient memory to store information identifying an animal and an ownership, medical, and production history of the animal, to toggle into an active mode about 200 times per day (about 8-9 times per hour). Typically, the tag will remain in the active mode for about 5 milliseconds or less per activation. During this time, the tag can communicate with a data manager interface and can write any updated information obtained from the data manager interface into memory.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the term “configured” describes a system, apparatus, or other structure that is constructed or configured to perform a particular task or adopt a particular configuration. The term “configured” can be used interchangeably with other similar phrases such as arranged and configured, constructed and arranged, adapted and configured, adapted, constructed, manufactured and arranged, and the like.

All publications and patent applications in this specification are indicative of the level of ordinary skill in the art to which this invention pertains.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. An identification tag for an animal, the tag comprising:
a first circuit including a memory subunit, a power subunit, and a first transmit subunit, the subunits electrically connected to each other;
an antenna electrically connected to the first circuit, the antenna being configured to receive radio signals, to induce an electrical current when a radio signal is received by the antenna, and to direct the induced electrical current to the power subunit; and
a power store electrically connected to the first circuit;
wherein the first transmit subunit of the first circuit is configured to transmit a first signal at a first frequency when the first transmit subunit receives electrical current from the power subunit, the first signal encoding at least a first portion of any data stored within the memory subunit; and
wherein the power subunit of the first circuit is configured to deliver at least some of the current induced by the antenna to the power store for storage, wherein delivering at least some of the current induced by the antenna to the power store recharges the power store.

2. The identification tag of claim 1, further comprising a second circuit including a second transmit subunit, the second circuit electrically connected to the first circuit, the second circuit being configured to transmit a second signal at a second frequency when it when it receives electrical current from the power subunit, the second signal encoding at least a second portion of any data within the memory subunit.

3. The identification tag of claim 2, wherein the first and second circuits are housed on separate integrated circuit substrates.

4. The identification tag of claim 2, wherein the second circuit is electrically connected to a second antenna and transmits the second signal via the second antenna.

5. The identification tag of claim 2, wherein the first frequency is lower than the second frequency.

6. The identification tag of claim 1, wherein the first frequency is approximately 134.2 KHz.

7. The identification tag of claim 1, wherein the power store includes a battery.

8. The identification tag of claim 1, wherein the power store includes a supercapacitor.

9. The identification tag of claim 1, wherein the first memory subunit stores a production history of the animal.

10. An animal identification tag comprising:
a flexible substrate including upper and lower portions;
a transponder mount positioned between the upper and lower portions, the transponder mount substantially rigid;
a transponder mounted to the transponder mount, the transponder including a data memory storage, an antenna, power circuitry, a rechargeable power store, and transmission circuitry, the power circuitry being configured to generate electrical current when a first radio signal at a first frequency is received by the antenna, the power store being configured to store at least a portion of the generated electrical current, the transmission circuitry being configured to transmit at least a portion of any data within the data memory storage at a second frequency;
a mounting opening extending through the upper and lower portions and a mounting opening reinforcement mounted between the upper and lower bodies adjacent the mounting opening.

11. The animal identification tag of claim 10, further comprising operator provided indicia printed on the exterior of the flexible substrate.

12. The animal identification tag of claim 10, wherein the transmission circuitry is configured to transmit the at least a portion of the data when electrical current is received from the power circuitry.
